(19) United States
(12) Patent Application Publication
(10) Pub. No.: US 2014/0061472 A1
(43) Pub. Date: Mar. 6, 2014

(54) MULTI-BAND READOUT INTEGRATED CIRCUITS AND RELATED METHODS

(71) Applicants: Kenneth R. Salvestrini, Tucson, AZ (US); Zhenwu Wang, Moorpark, CA (US); Hailing Guan, Oak Park, CA (US); David Dozor, Tucson, AZ (US)

(72) Inventors: Kenneth R. Salvestrini, Tucson, AZ (US); Zhenwu Wang, Moorpark, CA (US); Hailing Guan, Oak Park, CA (US); David Dozor, Tucson, AZ (US)

(73) Assignee: Infrared Laboratories, Inc., Tucson, AZ (US)

(21) Appl. No.: 13/615,987

(22) Filed: Sep. 14, 2012

Related U.S. Application Data
(60) Provisional application No. 61/534,692, filed on Sep. 14, 2011.

(51) Int. Cl. H04N 5/378

(52) U.S. Cl. CPC H04N 5/378
USPC 250/339.02; 250/208.1

(57) ABSTRACT

Readout integrated circuits (ROICs) for multi-band imagers, and related methods, are described. The ROICs may include multiple channels associated with the detectors of a photodetector array, with the different channels corresponding to different wavelength bands detected by the detectors. The ROICs may utilize capacitive transimpedance amplifier (CTIA) technology, and may implement time division multiplexing techniques.

### RELATED APPLICATIONS

This application claims the benefit under 35 U.S.C §119(e) of U.S. Provisional Application Ser. No. 61/534,692 filed Sep. 14, 2011 under Attorney Docket No. I0424.70000US00 and entitled “Multi-Band Readout Integrated Circuits and Related Methods,” the entire contents of which is incorporated herein by reference.

### FEDERALLY SPONSORED RESEARCH

This invention was made with government support under Contract # W909MY-10-C-0044 awarded by the Department of Defense (Defense Contract Management Agency). The government has certain rights in the invention.

### BACKGROUND

1. Field

The present application relates to multi-band readout integrated circuits and related methods.

2. Related Art

Readout integrated circuits are used in imagers to control readout of signals generated by the photodetectors of the imager. Some imagers detect two different wavelength bands by having one photodetector type to detect one wavelength band and a second photodetector type to detect another wavelength band. In some such imagers, the readout integrated circuit includes a separate connection to each photodetector of the imager. In another such imager, the readout integrated circuit is connected to two photodetectors at a single detector node via two direct injection field effect transistors (FETS).

### SUMMARY

According to one aspect, a readout integrated circuit (ROIC) is provided, comprising an operational amplifier having an inverting input configured to couple through a single connection to a first photodetector and a second photodetector of a photodetector array. The operational amplifier includes a non-inverting input configured to receive a reference voltage, and also includes an output configured to provide an output signal. The ROIC further comprises a first feedback capacitor coupled between the output of the operational amplifier and the inverting input of the operational amplifier, and a second feedback capacitor coupled between the output of the operational amplifier and the inverting input of the operational amplifier. The second feedback capacitor may be configured in parallel to the first feedback capacitor. The ROIC may further comprise a first sample and hold channel comprising a first sample and hold capacitor switchably coupled to the output of the operational amplifier by a first switch, and a second sample and hold channel comprising a second sample and hold capacitor switchably coupled to the output of the operational amplifier by a second switch. The second sample and hold channel may be configured in parallel to the first sample and hold channel. The first sample and hold channel may be configured to provide a first output signal indicative of detected radiation in a first wavelength band as detected by the first photodetector. The second sample and hold channel may be configured to provide a second output signal indicative of detected radiation in a second wavelength band as detected by the second photodetector.

According to another aspect, a readout integrated circuit (ROIC) is provided, comprising a capacitive transimpedance (CTIA) amplifier having an input, an output, a first feedback capacitor, a second feedback capacitor, a first switch, and a second switch. The input may be configured to be coupled to a detector. The first feedback capacitor and first switch may be coupled between the output and the input to form a first feedback loop. The second feedback capacitor and the second switch may be coupled between the output and the input to form a second feedback loop in parallel with the first feedback loop.

According to another aspect, a method of operating a readout integrated circuit (ROIC) configured to couple to a photodetector array is provided, the method comprising integrating a photocurrent from a detector of the photodetector array on a first feedback capacitor of a capacitive transimpedance (CTIA) amplifier during a first time period and integrating the photocurrent from the detector of the photodetector array on a second feedback capacitor of the capacitive transimpedance amplifier during a second time period. The method further comprises sampling an output voltage of the capacitive transimpedance amplifier.

According to another aspect, a method of operating a readout integrated circuit (ROIC) is provided. The method comprises alternately integrating photocurrent on first and second feedback capacitors of a same capacitive transimpedance amplifier to selectively integrate photocurrent corresponding to a first wavelength band of radiation on the first feedback capacitor and photocurrent corresponding to a second wavelength band of radiation on the second feedback capacitor.

### BRIEF DESCRIPTION OF DRAWINGS

Various aspects and embodiments of the technology will be described with reference to the following figures. It should be appreciated that the figures are not necessarily drawn to scale. Items appearing in multiple ones of the figures are indicated by the same or a similar reference number in all the figures in which they appear.

FIG. 1 is a block diagram of a non-limiting example of an imager including a detector array and a readout integrated circuit (ROIC), according to one embodiment.

FIG. 2 illustrates a non-limiting example of a detector array which may be used in combination with readout integrated circuits as described herein.

FIG. 3 is a block diagram of a non-limiting example of a readout integrated circuit, according to one embodiment.

FIG. 4 is a block diagram illustrating a pixel of a readout integrated circuit having two processing channels dedicated to a single detector, according to a non-limiting embodiment.

FIG. 5 illustrates a non-limiting detailed implementation of the pixel of FIG. 4, according to one embodiment.

FIG. 6 illustrates a timing diagram of the operation of a readout integrated circuit, according to one non-limiting embodiment.

FIG. 7A illustrates a cross-section of a non-limiting example of a semiconductor substrate having vertically stacked capacitors of a readout integrated circuit, according to a non-limiting embodiment.

FIG. 7B illustrates a cross-section of a non-limiting example of a substrate stack in which components of a ROIC pixel may be divided between the substrates.

FIG. 8 is a block diagram illustrating circuitry suitable for implementing different integration period durations between rows of an imaging array, according to one non-limiting embodiment.

FIG. 9 is a flowchart illustrating a method of generating timing signals for controlling integration of an imaging pixel, according to one non-limiting embodiment.

FIGS. 10A and 10B illustrate timing signals for implementing different integration period durations between rows of an imaging array of pixels of the type in FIG. 5 in snapshot mode and ripple mode, respectively, according to one non-limiting embodiment.

FIG. 11 illustrates a column buffer having an amplifier with variable gain that may be used to provide inter-row variable gain as described herein, according to one non-limiting embodiment.

FIG. 12 illustrates an example of a configuration of the amplifier of FIG. 11 in which the gain of the amplifier may be varied using feedback capacitors, according to a non-limiting embodiment.

FIG. 13 illustrates a variation on the configuration of FIG. 5.

FIG. 14 illustrates a non-limiting example of an imaging device comprising a photodetector array and a readout integrated circuit, according to one embodiment.

### DETAILED DESCRIPTION

Applicants have appreciated that conventional dual band imagers are unsatisfactory for imaging at low light levels. Direct injection techniques conventionally employed in the read out integrated circuits (ROICs) of dual band infrared (IR) imagers are designed based on the relatively high photon flux densities/photon irradiances associated with certain IR wavelength bands, such as medium wavelength infrared (MWIR) radiation and long wavelength infrared (LWIR). The use of capacitive transimpedance amplifier (CTIA) technology has not been used for such wavelengths owing to the relatively high photon shot noise associated with the relatively high background irradiance levels for such wavelengths. Yet, the conventional direct injection technology suffers from charge injection inefficiencies causing signal loss at low photon flux levels and is too noisy to produce satisfactory results at low photon flux levels. Such direct injection techniques typically exhibit significantly degraded performance below photon flux densities/photon irradiances of 5×10¹⁴ photons/cm²-s.

Accordingly, one non-limiting aspect of the present application provides a ROIC utilizing capacitive transimpedance amplifier (CTIA) technology, and which may be suitable for connecting to each detector (or pixel, e.g., pair of photodetectors) of a dual band or multi-band (multi-color) photodetector array (e.g., a multispectral imager) via a single electrical connection (for example, via a single bump bond, such as an indium bump bond). As a non-limiting example, a single CTIA amplifier of the ROIC may be coupled to (or couplable to) multiple photodetectors of a detector array via a single electrical connection. The ROIC may further include, for each detector unit of a photodetector array, separate processing channels corresponding to each wavelength band detected by the detector unit. As a non-limiting example, in those embodiments in which a dual band imager is implemented, the ROIC may include, for each pair of photodetectors of the dual band imager, a single CTIA amplifier coupled at its output to two parallel processing channels, with each of the processing channels corresponding to one of the wavelength bands detected by the photodetectors of the detector unit. Each processing channel may be configured to capture, store, and subsequently output a charge (or more generally, a signal) indicative of an amount of radiation within a corresponding wavelength band, and in at least some embodiments may represent sample and hold channels or output channels. Thus, according to at least one aspect, a ROIC for a multispectral imager (e.g., a dual band compact hyperspectral imager (DBCHI)) may include multiple processing channels sharing a CTIA amplifier, with the CTIA amplifier integrating photocurrent provided by photodetectors of the imager.

According to another non-limiting aspect of the present application, a method of operating a ROIC for a dual band or multi-band photodetector array is provided, which is suitable for ROICs that implement CTIA technology and that are configured to couple to multiple photodetectors of the photodetector array though a single electrical connection. The method according to this non-limiting aspect comprises alternately integrating photocurrent from a detector of the photodetector array on multiple parallel feedback capacitors of a CTIA amplifier. By suitably selecting the times at which photocurrent from the detector is integrated onto the feedback capacitors, different ones of the feedback capacitors may integrate photocurrent corresponding to different wavelength bands detected by the detector. A voltage at the output of the CTIA amplifier may be sampled onto storage capacitors (e.g., sample and hold capacitors) at alternate times, such that different storage capacitors of the ROIC may store charge corresponding to the different wavelength bands detected by the detector. The charge (or voltage) on the storage capacitors may then be suitably read out to provide separate signals indicative of the amount of radiation in the different wavelength bands detected by the detector.

According to at least some non-limiting embodiments of the above-described aspect, integration of the photocurrent on the feedback capacitors may comprise alternating between the feedback capacitors multiple times during a single integration period of the detector. In this manner, temporal correlation (or registration) between images formed for the different wavelength bands may be maximized. The number of times during an integration period that the integration is alternated between different ones of the feedback capacitors, and the duration of integration on each of the feedback capacitors, may be selected to provide a desired level of temporal correlation.

In some non-limiting embodiments, the above-described aspects may be used with a photodetector array having photodetectors that are spatially correlated for the different wavelength bands detected by the array. For example, a photodetector array implementing back-to-back photodiodes (e.g., back to back PIN photodiodes) may be used in connection with the above described aspect of operating a ROIC. In this manner, images may be generated for the different wavelength bands that are both spatially and temporally correlated.

According to another non-limiting aspect, a ROIC includes vertically stacked capacitors. As described above, a ROIC configured to be coupled to a detector unit including multiple photodetectors may include a CTIA amplifier having multiple feedback capacitors, as well as multiple processing channels coupled to an output of the CTIA amplifier, with each of the processing channels including at least one sample and hold capacitor. According to the present aspect, the ROIC may be formed in a substrate (e.g., a semiconductor substrate) and at least two of the capacitors of the ROIC may be vertically stacked in relation to each other. In this manner, space on the substrate may be conserved, and the size of the ROIC may therefore be minimized. The vertical stacking may be accomplished in any suitable manner, and any suitable capacitors of the ROIC may be vertically stacked with respect to each other.

According to another non-limiting aspect, an imager having inter-row variable gain is described. An imager implementing a photodetector array may be subject to non-uniformities in received incident power between rows of the array (i.e., differences may be manifested in different rows of the array), especially when coupled with a grating, prism, grism, or other device that separates incident light into various wavelengths or energy bands. Thus, according to the present aspect, an imager comprising inter-row variable gain across the detector array may be provided. Such variable gain of the imager may account for the above-described non-uniformities, though the present aspect is not limited to implementing vertical variable gain for any particular reason. According to one non-limiting embodiment, the inter-row variable gain may be achieved by implementing different integration times for different rows of the detector array. However, other techniques for implementing inter-row variable gain may be utilized, and the present aspect is not limited to any particular manner of implementation.

The aspects described above, as well as additional aspects, are described further below. These aspects may be used individually, all together, or in any combination of two or more, as the technology is not limited in this respect. Moreover, for purposes of explanation, the following discussion focuses on scenarios in which a dual band imager is contemplated. However, it should be appreciated that at least some of the aspects described herein may apply to scenarios in which more than two wavelength bands are to be detected.

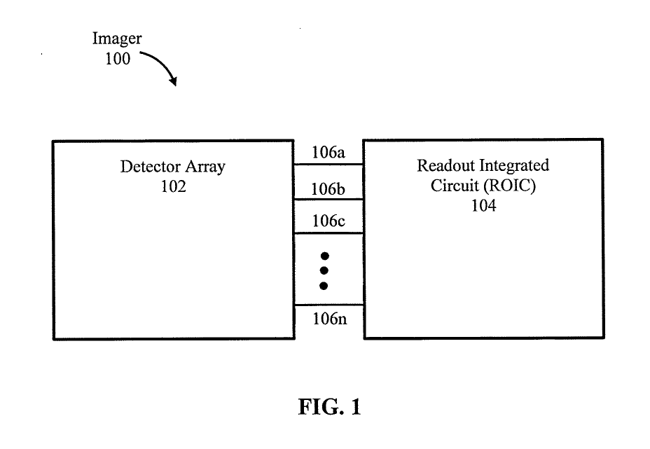

A non-limiting example of an imager to which various aspects of the present application may apply is illustrated in FIG. 1. As shown, the imager 100 includes a detector array 102 (e.g., a focal plane array or imaging array) and a read out integrated circuit (ROIC) 104. The detector array 102 and ROIC 104 may be connected to each other via connections 106a, 106b, 106c . . . 106n. The connections may be any suitable connections, such as wire bonding connections, bump bonds, or any other suitable interconnections. In some embodiments, the detector array 102 may be formed on a first substrate (for example, a first semiconductor substrate) while the ROIC 104 may be formed on a separate substrate. However, not all embodiments are limited in this respect.

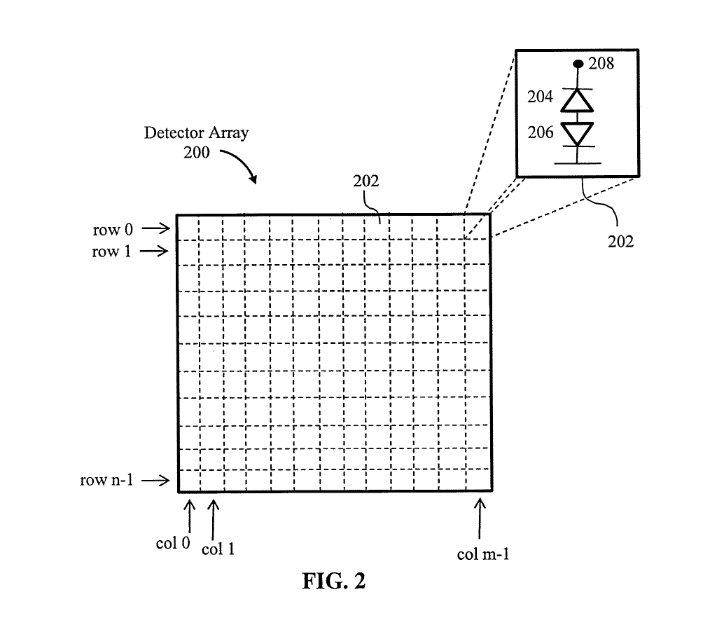

As mentioned previously, one or more aspects of the present application may apply to multi-band imagers capable of detecting multiple different wavelength bands. As a non-limiting example, aspects of the present application may apply to a dual band imager including a detector array capable of detecting incident radiation in two wavelength bands. A non-limiting example of a suitable detector array 200 is illustrated in FIG. 2.

The detector array 200 may be used as the detector array 102 in imager 100, though other types of detector arrays may alternatively be used. As shown, the detector array 200 includes a plurality of detectors 202 (also referred herein as detector units, pixels, or imaging pixels) arranged in an array of n rows and m columns. As shown in the inset illustrating an enlarged view of a single detector 202, each detector may include two photodiodes 204 and 206. The photodiodes may be configured as back-to-back photodiodes, as illustrated, and may share a common output node 208. Photodiode 204 may be suitable to detect a first wavelength band while photodetector 206 may be suitable to detect a second wavelength band. As a non-limiting example, photodetector 204 may be configured to detect medium wavelength infrared (MWIR) wavelengths while photodiode 206 may be configured to detect long wavelength infrared (LWIR) wavelengths. It should be appreciated, however, that the various aspects described herein relating to dual band and multi-band imagers are not limited to the specific wavelengths detected unless otherwise stated.

It should be appreciated, however, that the various aspects described herein are not limited to use with any particular type of detector array, and therefore that the configuration of FIG. 2 is provided for purposes of illustration and not limitation. For instance, rather than back-to-back photodiodes, two photodiodes of different polarity may be used (e.g., one p-n photodiode and one n-p photodiode, as a non-limiting example). Non-limiting examples of suitable detector types include pin-diodes (e.g., single diodes or in back-to-back format), though other types are also possible. The diodes may be mercury cadmium telluride (MCT) photodiodes, InAs/GaSb diodes, Quantum Well Infrared Photodiodes (QWIPs), or Type II Superlattice diodes, as non-limiting examples. Thus, in some non-limiting embodiments, third generation infrared detectors may be used, though not all embodiments are limited in this respect. Other types and configurations of photodetectors are also possible, as again the various aspects described herein are not limited to use with any particular type of detector array.

Referring again to the configuration of FIG. 2, in a non-limiting example, photodiodes 204 and 206 may be suitably biased to provide an output signal indicative of a desired wavelength range. For example, photodiode 204 may be suitably biased to be conductive in response to receiving radiation in its targeted wavelength band, while photodiode 206 may be biased to be non-conducting. In such situations, an output signal at node 208 may be representative of radiation detected by photodiode 204. Similarly, photodiode 206 may be biased to conduct in response to receiving radiation in its targeted wavelength band, while photodiode 204 may be biased to be non-conducting. In such situations, a signal at node 208 may be indicative of radiation detected by photodiode 206. Thus, the biasing of the photodiodes may determine whether the signal output from detector 202 represents detected radiation in the first wavelength band or the second wavelength band.

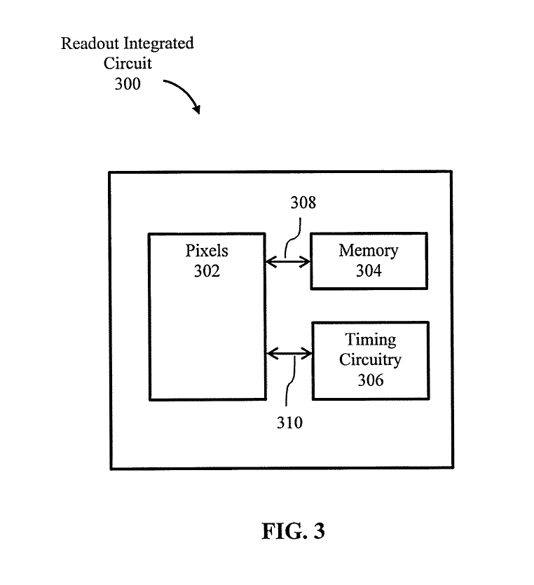

FIG. 3 is a block diagram of a non-limiting ROIC 300 according to an embodiment of the present application, and which may be used in the imager 100 and in connection with a detector of the type illustrated in FIG. 2. As shown, the ROIC 300 may include a plurality of pixels 302 (alternatively referred to herein as unit cells or ROIC cells), a memory 304, and timing circuitry 306, among other things. The pixels may represent circuitry of the ROIC dedicated to a particular detector of a photodetector array. Non-limiting examples are illustrated and discussed below. The timing circuitry 306 may be used to generate timing signals (also referred to herein as clock signals or control signals) for controlling the plurality of pixels 302. The memory 304 may store values used by the timing circuitry 306 to produce suitable timing signals. The memory 304 may also store any other suitable values used to control the plurality of pixels 302 or otherwise used in the operation of ROIC 300. The memory and timing circuitry may communicate with the pixels 302 in any suitable manner, for example, via bidirectional links 308 and 310. Alternatively a data bus may be utilized.

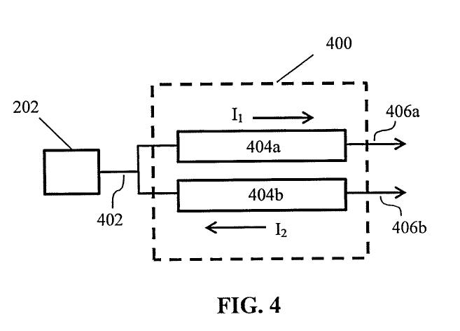

A non-limiting example of a ROIC pixel (e.g., a pixel 302 of FIG. 3) which may be associated with a detector of a photodetector array is illustrated in FIG. 4, and now described. As shown, the pixel 400 may be coupled to a detector such as detector 202 of FIG. 2, or any other suitable dual band or multi-band detector. The connection may be via a connection (or link) 402, which may take any suitable form, such as a wire bond connection, a bump bond connection, or any other suitable connection.

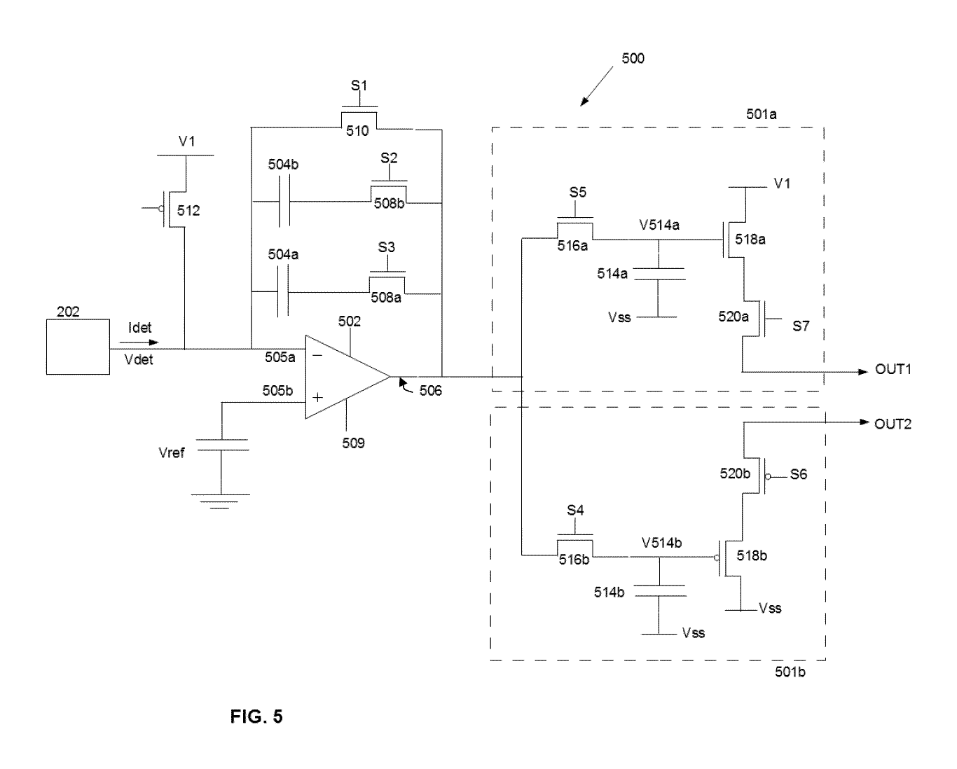

As shown, the pixel 400 comprises two channels 404a and 404b, producing respective output signals 406a and 406b. Channel 404a may include circuitry suitable for processing output signals from detector 202 corresponding to a first wavelength band, while channel 404b may include circuitry suitable for processing output signals of detector 202 corresponding to a second wavelength band. Thus, channels 404a and 404b may be termed processing channels, but, as should be appreciated from the non-limiting examples described herein, may also be termed output channels. As a non-limiting example, channel 404a may include, among other things, circuitry suitable for integrating and/or sampling and/or storing and/or outputting a charge (or, more generally, a signal) indicative of an amount of incident radiation in a first wavelength band provided by detector 202. Thus, output signal 406a may be indicative of the amount of incident radiation in the first wavelength band. Likewise, channel 404b may include circuitry suitable for integrating and/or sampling and/or storing and/or outputting a charge (or, more generally, a signal) indicative of an amount of incident radiation in a second detected wavelength band, as detected by detector 202. Thus, output signal 406b may be indicative of the amount of radiation detected in the second wavelength band. In at least some non-limiting embodiments, the channels 404a and 404b may be sample and hold channels, each including sample and hold circuitry. According to at least one non-limiting embodiment, one or both of channels 404a and 404b includes CTIA circuitry. However, alternatives are possible. For example, one or more of the aspects described herein may also apply to or implement direct injection pixels, Buffered Direct Injection (BDI) pixels, Gain Modulation (GMI or GMOD) pixels, Time Delay and Integrate (TDI) pixels, source follower (SF) pixels, active pixels, and CMOS pixels, as non-limiting examples. Further alternatives are possible. Furthermore, as should be appreciated from the discussion of FIG. 5, below, according to some embodiments of the present application processing channels of a ROIC may share one or more components, such as a CTIA amplifier. The illustrated configuration of FIG. 4 is not meant to preclude such a configuration in which the channels share circuitry.

As also illustrated in FIG. 4, according to some embodiments a ROIC pixel including multiple processing channels is configured to allow current flow in opposite directions in the channels. For example, a current I₁ may flow in a first direction in channel 404a when that channel is conducting (e.g., away from the detector 202), whereas a current I₂ may flow in channel 404b in the opposite direction when that channel is conducting. Such operation will be explained in further detail below with respect to FIG. 5, and may be caused in some embodiments by use of back-to-back photodetectors in the detector 202. Thus, it should be appreciated that according to one aspect of the application, a ROIC configured to be coupled to a dual band detector array is configured to allow current flow in the ROIC both toward and away from the detector (e.g., into and out of the detector).

FIG. 5 illustrates a non-limiting detailed implementation of a ROIC pixel (alternatively referred to herein as a unit cell or ROIC cell) of the type illustrated in FIG. 4, according to one non-limiting embodiment. It should be appreciated, however, that alternative detailed implementations may be used, while still using one or more aspects of the present application. Thus, FIG. 5 is a non-limiting example.

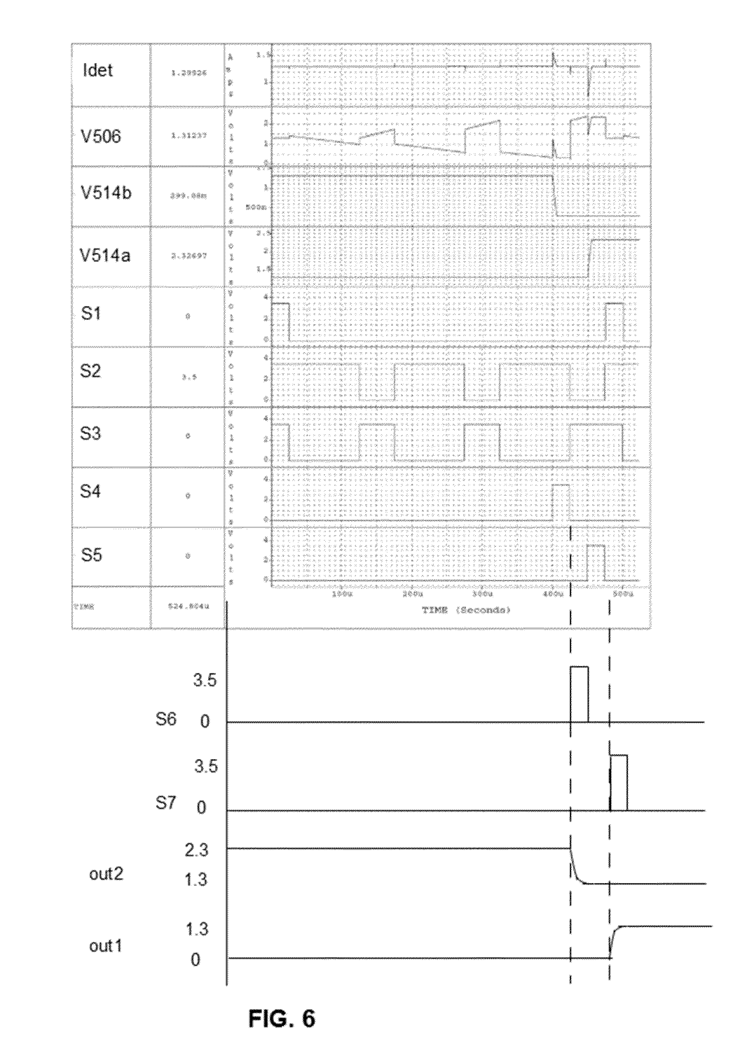

As shown, pixel 500 includes a single CTIA amplifier having an input coupled to detector 202 and an output coupled to two processing channels 501a and 501b. Thus, the processing channels 501a and 501b may be thought of as sharing a single amplifier. The CTIA amplifier includes an operational amplifier 502 and multiple feedback capacitors 504a and 504b. According to one non-limiting embodiment, the pixel includes one processing channel for each of the wavelength bands detected by detector 202, and the CTIA amplifier includes one or more feedback capacitors corresponding to each of the processing channels. Thus, the configuration of FIG. 5 may correspond to the non-limiting scenario in which detector 202 detects two wavelength bands of radiation (e.g., using a photodiode structure like that illustrated in FIG. 2), such that one of the two processing channels may correspond to one of the detected wavelength bands and the second processing channel may correspond to the other of the detected wavelength bands. Likewise, one of the two illustrated feedback capacitors may be used in conjunction with detection of one of the wavelength bands, while the other of the illustrated feedback capacitors may be used in conjunction with detection of the second of the wavelength bands. Further details with respect to the operation of the pixel 500 are discussed below in connection with FIG. 6.

As mentioned, the operational amplifier 502 may be coupled to (or couplable to) the detector 202 at one of its inputs, for example at the inverting input 505a of the operational amplifier, as shown. The connection may be a single electrical connection, for example formed by or including a wire bond, a single bump bond (e.g., an indium bump bond or any other suitable bump bond), or any other suitable interconnection. According to an aspect of the present application, a single electrical connection for connecting the ROIC pixel to the detector is used even though the detector may have multiple photodetectors for detecting different wavelength bands. The second input 505b of the operational amplifier may be coupled to receive a reference voltage V_{ref}, which may be any suitable reference voltage.

As mentioned with respect to FIG. 4, and as should also be appreciated from the configuration of FIG. 5, ROICs according to one or more aspects described herein may accommodate current flow in opposing directions in the ROIC (e.g., both into and out of the detector). Selection of a suitable value of V_{ref} may facilitate such operation. For example, the value of V_{ref} may be selected to allow for anticipated voltage differences between V_{ref} and the voltage at input 505a of the operational amplifier. As one specific non-limiting example, the global power supply voltage for the pixel 500 may be approximately 3.5 Volts and V_{ref} may be selected to be approximately 1.3 Volts, which may be higher than if the ROIC pixel was designed to accommodate current flow in only one direction.

As shown in FIG. 5, the operational amplifier may also include a bias input 509, though not all embodiments are limited in this respect. Any suitable bias value may be applied.

The feedback capacitors 504a and 504b may be part of switchable feedback loops. As shown, a first feedback loop between the output 506 of the operational amplifier 502 and the input 505a of the operational amplifier 502 may include feedback capacitor 504a and switch 508a (e.g., a metal oxide semiconductor field effect transistor (MOSFET), such as an n-channel MOSFET). A second feedback loop between the output 506 of the operational amplifier 502 and the input 505a of the operational amplifier 502 may include feedback capacitor 504b and switch 508b (e.g., an n-channel MOSFET). The switches 508a and 508b may be controlled with signals S₃ and S₂, respectively, and may be used to switch (i.e., open or close) the feedback loops, thus connecting or disconnecting the feedback capacitors from the operational amplifier. As will be described in greater detail below with respect to FIG. 6, such switching may be used to selectively integrate charge on the feedback capacitors corresponding to respective wavelength bands. Thus, the feedback loops may be referred to alternatively herein as integration loops or paths (i.e., the dual band ROIC pixel of FIG. 5 may be described as including two integration paths). Also, it should be appreciated from FIG. 5 that the feedback loops may be parallel to each other, which may facilitate selective integration of photocurrent on different ones of the feedback capacitors at different times.

A reset switch 510 (e.g., an n-channel MOSFET) may also be provided in parallel to the capacitive feedback loops. The reset switch may reset the feedback capacitors 504a and 504b when activated (closed). When activated, the reset switch may also set the voltage at the output 506 of the amplifier 502 to the reference voltage Vref (approximately 1.3 Volts, as a non-limiting example) by short circuitry the output 506 of the operation amplifier to the input 505b. The reset switch may be controlled by a signal S₁. The reset switch may be closed, for example, at the beginning or end of an integration period to reset the feedback capacitors (e.g., to clear integrated charge from the feedback capacitors). However, not all embodiments are limited to having a reset switch 510 or using it in the manner described.

A switch 512 (e.g., a p-channel MOSFET) may also be provided to connect the input 505a of the operational amplifier to a bias voltage (e.g., a global supply voltage V1, or any other suitable voltage). Such a switch may operate as a skimming circuit, for example to skim dark current from the ROIC pixel as needed. Accordingly, the switch 512 may be operated in any suitable manner to minimize (or reduce entirely) dark current from the pixel 500. Other configurations for a skimming circuit may also be used, and in some embodiments a skimming circuit may not be included, as it is optional.

The processing channels 501a and 501b may be used to sample and/or store and/or output charge indicative of an amount of radiation detected by the detector 202 in a corresponding wavelength band. As a non-limiting example, assuming that the detector 202 detects radiation in the MWIR and LWIR bands (e.g., by using photodiodes specific to each band), the processing channel 501a may be configured to sample a voltage from the operational amplifier 502 indicative of detected radiation in the LWIR band, while the processing channel 501b may be configured to sample a voltage from the operational amplifier 502 indicative of detected radiation in the MWIR band. The processing channels may then also output signals indicative of the sampled voltages, and therefore indicative of the detected radiation in the respective bands (e.g., output signals OUT1 and OUT2, discussed further below). Accordingly, the processing channels 501a and 501b may be considered output channels. The processing channels may have any suitable configuration(s) for performing the described functions (e.g., sampling and/or storing and/or outputting signals), and the sample and hold configurations shown in FIG. 5 are non-limiting.

In greater detail, the processing channel 501a may include a sample and hold capacitor 514a (or, more generally, a storage capacitor) switchably coupled to the output 506 of the operational amplifier via a switch 516a (e.g., an n-channel MOSFET), which itself may be controlled by a signal S₅. One end of the sample and hold capacitor may be coupled to a supply rail or voltage (e.g., a global supply voltage) Vₛₛ. The sample and hold configuration may facilitate operation of the ROIC in snapshot mode, though the various aspects described herein are not limited to snapshot mode (e.g., other modes, such as ripple mode, described below, rolling shutter mode, and interleaving of frames may alternatively be used).

The processing channel 501a may also include output circuitry, such as transistors 518a and 520a. As a non-limiting example, the output circuitry may include a source follower configuration, though not all embodiments are limited in this respect. The output circuitry may be coupled to the sample and hold capacitor 514a and configured in any suitable manner to provide an output signal OUT1 indicative of the charge stored on the sample and hold capacitor 514a, and therefore indicative of the radiation detected by detector 202 in a particular wavelength band. The output signal OUT1 may be provided in response to a readout signal (or transfer signal) S₇ being supplied to transistor 520a, as shown. The output signal OUT1 may be provided to column circuitry (e.g., a column line or bus, a column buffer, etc.) connecting or multiplexing multiple pixels of the ROIC, or may be provided to any other suitable destination, as the various aspects described herein are not limited in this respect. As a non-limiting example, the source of transistor 520a may connect to a column bus.

The processing channel 501b may be similar in design to the processing channel 501a. In some embodiments, the processing channels 501a and 501b may be substantially the same in design, or identical. For example, as shown, the processing channel 501b includes a sample and hold capacitor 514b (or, more generally, a storage capacitor) switchably coupled to the output 506 of the operational amplifier 502 via a switch 516b (e.g., an n-channel MOSFET), which itself may be controlled by a signal S₄. The sample and hold configuration may facilitate operation of the ROIC in snapshot mode, though the various aspects described herein are not limited to snapshot mode.

The processing channel 501b may also include output circuitry, such as transistors 518b (e.g., a p-channel MOSFET) and 520b (e.g., a p-channel MOSFET). As a non-limiting example, the output circuitry may include a source follower configuration, though not all embodiments are limited in this respect. The output circuitry may be coupled to the sample and hold capacitor 514b and configured in any suitable manner to provide an output signal OUT2 indicative of the charge stored on the sample and hold capacitor 514b and therefore indicative of the radiation detected by detector 202 in a particular wavelength band. The output signal OUT2 may be provided in response to a readout signal (or transfer signal) S₆ being supplied to transistor 520b, as shown. The output signal OUT2 may be provided to column circuitry (e.g., a column line or bus, a column buffer, etc.) connecting or multiplexing multiple pixels of the ROIC, or may be provided to any other suitable destination, as the various aspects described herein are not limited in this respect. As a non-limiting example, the source of transistor 520b may connect to a column bus.

Again, the configuration of FIG. 5 is a non-limiting example of a suitable configuration of a ROIC pixel for connecting to a detector 202 via a single connection and processing signals from the detector 202 corresponding to multiple (e.g., two) wavelength bands. Alternative configurations are possible, including alternative ordering of components and use of alternative components.

Moreover, the various components illustrated in FIG. 5 may have any suitable values. For example, the capacitors (i.e., the feedback capacitors and sample and hold capacitors) may have any suitable capacitances to provide suitable operation in terms of integrating photocurrent from a detector 202. In some embodiments, the values of the capacitances may be selected based on, for example, current magnitudes expected to be generated by the detector 202 in response to receiving incident radiation, which in turn may be dependent on expected flux densities of the wavelength bands. In some embodiments, the feedback capacitances may differ in value, though not all embodiments are limited in this respect. As a non-limiting example, a 5:1 ratio between the capacitance value of capacitor 504a and the capacitance value of capacitor 504b may be implemented (e.g., capacitor 504a may be approximately 100 femtoFarads while capacitor 504b may be approximately 20 femtoFarads). Such a ratio may be appropriate when, for example, capacitor 504a is intended to integrate charge corresponding to detection of LWIR radiation and capacitor 504b is intended to integrate charge corresponding to detection of MWIR radiation. Non-limiting alternative ratios between the capacitance of 504a and the capacitance of 504b may include 4:1, 3:1, and 2:1, or any other suitable ratio. These, however, are non-limiting examples, and it should be appreciated that suitable ratios and suitable absolute capacitance values may be selected depending on expected intensity differences between the different wavelength bands to be detected.

Likewise, the capacitors 514a and 514b may have any suitable values, including the same value as each other or different values. According to one non-limiting embodiment, both capacitors 514a and 514b may be approximately 0.25 picoFarads (pF), though alternative values are possible.

It should also be appreciated that while various switches in FIG. 5 are illustrated as FETs, the embodiments described herein including switches are not limited to use of any particular type of switch. For example, other types of transistors may be used (e.g., junction field effect transistors (JFETs), bipolar junction transistors (BJTs)), or other types of switches. Furthermore, in those embodiments in which FETs are used as switches, the FETs may be any suitable type of FETs and may have any suitable polarity (n-type, p-type, etc.).

The switches may be controlled by any suitable timing signals S (also referred to herein as control signals or clock signals), examples of which are discussed below in connection with FIG. 6. The timing signals may be generated by any suitable signal generation circuitry, such as, for example, timing circuitry 306 of FIG. 3.

It should also be appreciated that the configuration of FIG. 5 represents a non-limiting example of a pixel of a ROIC in which multiple processing channels share an amplifier. Such a configuration may result in substantial space savings in the physical implementation of the pixel 500 (e.g., when implemented on a semiconductor substrate) compared to providing dedicated amplifiers for each processing channel.

For completeness, it should be appreciated that the feedback capacitors 504a and 504b may be considered to be part of separate channels of the ROIC pixel (e.g., the feedback capacitor 504a may be considered part of the processing channel 501a and the feedback capacitor 504b may be considered part of the processing channel 501b). Thus, for instance, the pixel 500 may be described as including one channel comprising the feedback loop of capacitor 504a and switch 508a together with the processing channel 501a. Similarly, the pixel 500 may be considered to include a second channel comprising the feedback loop of capacitor 504b and switch 508b together with the processing channel 501b. In such scenarios, the operational amplifier may be considered to be part of both channels or neither channel, and the various embodiments described herein are not limited in this respect.

Further still, it should be appreciated that ROIC pixels according to one or more of the various aspects described herein are not limited to having only two processing channels share a CTIA amplifier. Rather, one or more of the aspects described herein may be applied to multi-band detection detecting more than two wavelength bands (e.g., three wavelength bands, four wavelength bands, etc.). Any suitable number of processing channels may be configured to share a CTIA amplifier as appropriate for processing signals relating to a desired number of wavelength bands while still connecting to a detector through a single connection (e.g., a single bump bond). Likewise, a CTIA amplifier may have any suitable number of feedback loops, and in some embodiments a separate feedback loop corresponding to each processing channel. As a non-limiting example, the pixel of FIG. 5 may be extended to operate with a detector 202 configured to detect three wavelength bands of radiation by adding a processing channel and also a feedback capacitor to the operational amplifier.

A non-limiting example of operation of the pixel 500 of FIG. 5 will now be described. Because various components of the pixel 500 intended for use in processing different wavelength bands share an amplifier, and therefore access to the detector 202, Applicants have appreciated that a suitable manner of operating a ROIC pixel of the type illustrated may involve time division multiplexing, or other suitable timing sharing schemes.

According to one aspect of the present application, time sharing of a CTIA amplifier is used to selectively integrate photocurrent corresponding to different wavelength bands on a different capacitors of a ROIC pixel. Referring to FIG. 5, for example, photocurrent from the detector 202 may be selectively integrated onto feedback capacitors 504a and 504b such that those capacitors store voltages indicative of first and second wavelength bands detected by the detector 202, respectively. As a non-limiting example, the detector 202 may include back-to-back photodiodes which detect radiation in first and second wavelength bands, respectively. The output current I_{det} (and corresponding voltage V_{det}) from detector 202 may at one time represent detection of the first wavelength band (e.g., when the photodiode corresponding to the first wavelength band is suitably biased) while at another time may represent detection of the second wavelength band (e.g., when the photodiode corresponding to the second wavelength band is suitably biased). Thus, for example, the capacitor 504a may be selected to integrate photocurrent from detector 202 when the photocurrent corresponds to detection of the first wavelength band, while the capacitor 504b may be selected to integrate the photocurrent when the photocurrent corresponds to detection of the second wavelength band. Suitable synchronization between selection of the capacitors 504a and 504b and the biasing of photodiodes in detector 202 (for example, if the detector 202 includes back-to-back photodiodes) may be used to perform selective integration of photocurrent corresponding to different wavelength bands. Suitable sampling of the voltage V₅₀₆ at the output 506 of operational amplifier 502 may then be performed to store charge on capacitors 514a and 514b corresponding to the respective wavelength bands.

In some scenarios, temporal correlation between detection of different wavelength bands may be desired, such that images produced for the different wavelength bands may accurately reflect the same time, as closely as possible. Because time sharing of the CTIA amplifier of FIG. 5 is used, some temporal mismatch between wavelength bands may occur. Applicants have appreciated that the mismatch may be minimized, and therefore the temporal correlation improved, by alternately integrating photocurrent corresponding to the different wavelength bands detected during a single integration period. In this sense, detection of one wavelength band may be temporally “interleaved” with detection of another band. A non-limiting example is now described with respect to FIG. 6.

FIG. 6 illustrates signal traces corresponding to one manner of operation of a ROIC of the type illustrated in FIG. 5. Traces are shown for the current output I_{det} of detector 202 (in Amps), the voltage V₅₀₆ at the output 506 of operational amplifier 502, the voltages V₅₁₄ₐ and V_{514b} of capacitors 514a and 514b, respectively, the timing signals S₁-S₇ supplied to various ones of the switches as shown in FIG. 5, and the signals OUT1 and OUT2. All voltages in FIG. 6 are in Volts. The behavior illustrated is for a single integration period of approximately 500 microseconds. It should be appreciated, however, that other time durations are possible and that the illustrated timing is a non-limiting example.

At the beginning of the illustrated integration period, signal S₁, which is provided to the reset switch 510, is high, thus resetting the voltage V₅₀₆ to its default value approximately equal to the value of V_{ref}. As mentioned previously, a non-limiting example of the value of V_{ref} is 1.3 Volts, such that at the beginning of the timing diagram of FIG. 6 the value of V₅₀₆ is approximately 1.3 Volts. It should be appreciated that the voltages used may depend, at least partially, on the design rules used in designing the pixel, the fabrication process used in making the pixel, or other design/manufacturing considerations. The illustrated reset action may correspond to the beginning of a new integration period in which previously stored charge is cleared from the circuit.

Subsequently, the reset switch 510 is turned off (when S₁ goes low, at approximately 25 microseconds) and integration of photocurrent I_{det} begins. As shown, between the end of the reset action (at approximately 25 microseconds) and approximately 400 microseconds, the polarities of signals S₂ and S₃ alternate. Correspondingly, the states of switches 508b and 508a alternate, and thus the photocurrent I_{det} is alternately integrated on feedback capacitors 504b and 504a. More specifically, the photocurrent I_{det} is integrated on capacitor 504a while S₃ is high and is integrated on capacitor 504b while S₂ is high. The corresponding voltage behavior at the output 506 of operational amplifier 502 can be seen from the trace of V₅₀₆.

After integration of the photocurrent has proceeded in the described manner for a suitable (or desired) amount of time, the voltages stored on capacitors 504a and 504b are sampled by channels 501a and 501b. More specifically, in the non-limiting example shown, switch 516b is turned on at approximately 400 microseconds by sending S₄ high, thus sampling the voltage V₅₀₆ at that time onto the sample and hold capacitor 514b. The voltage V₅₀₆ at that time corresponds to the voltage on feedback capacitor 504b since S₂ is also high at that time. The resulting change in the voltage V_{514b} of capacitor 514b can be seen in FIG. 6 at approximately 400 microseconds. Switch 516b is then closed by sending S₄ low and subsequently, at approximately 450 microseconds, switch 516a is turned on by sending S₅ high, thus sampling the voltage V₅₀₆ at that time onto the sample and hold capacitor 514a. The voltage V₅₀₆ at that time corresponds to the voltage on feedback capacitor 504a since S₃ is also high at that time. The resulting change in voltage V₅₁₄ₐ of capacitor 514a can be seen in FIG. 6 at approximately 450 microseconds.

The output signals OUT1 and OUT2 may then be read out to column circuitry, as a non-limiting example, in response to readout signals S₆ and S₇, respectively, shown as assuming a high value at approximately 425 microseconds and 475 microseconds, respectively.

Subsequently, the pixel may be reset by sending S₁ high at approximately 475 microseconds to begin new integration period.

As should be appreciated from the foregoing discussion, operation of the pixel 500 in the manner illustrated in FIG. 6 may be used to sample and store charge separately on capacitors 514a and 514b corresponding to different wavelength bands detected by the detector 202. Thus, the operation may be used for a dual band imager.

Various features of the illustrated timing diagrams are worthy of further discussion. For instance, as mentioned, the actual timing illustrated is non-limiting. For example, while the integration period shown is approximately 500 microseconds in duration, that period may have any suitable value (e.g., between 500 microseconds and 1000 microseconds, between 200-600 microseconds, or any other suitable duration).

Furthermore, any suitable number and duration of alternating periods between integration on capacitors 504b and 504a (via alternating polarities of the signals S₂ and S₃) may be implemented. FIG. 6 illustrates the non-limiting example of three alternating periods, i.e., photocurrent is separately integrated three times (i.e., during three time periods (alternatively referred to as time intervals, or integration intervals)) on each of capacitors 504a and 504b between reset of the pixel and sampling of the voltage V₅₀₆. More or fewer alternating periods may be employed. For a given total integration period, the greater the number of alternating periods employed, the greater the temporal correlation between detection of the different wavelength bands. However, each switch between the capacitors 504a and 504b may result in charge injection, which may be undesirable. Therefore, the maximum desirable number of alternating periods between integrating on capacitors 504a and 504b may be determined, in some non-limiting embodiments, by an acceptable charge injection level.

The duration of the alternating periods may also take any suitable value(s). In some embodiments, the alternating periods (or time intervals) may be of approximately equal value, such that integration occurs on capacitors 504a and 504b for approximately equal durations. Alternatively, the alternating periods may have different values, such that, for example, integration on one of the feedback capacitors occurs for longer than does integration on the other of the feedback capacitors. In the non-limiting example of FIG. 6, signal S₂ is high for a greater duration than is signal S₃, meaning that integration on capacitor 504b is performed for a longer time than is integration on capacitor 504a. Such a difference in integration times may be selected for any reason, for instance to account for expected differences in flux levels between the different wavelength bands detected, or for any other reason. Accordingly, the amount of difference between the integration times of the different feedback capacitors may be selected to take any suitable values. In the non-limiting example of FIG. 6, signal S₂ is high for approximately 300 microseconds of the 500 microsecond integration period, while S₃ is high for approximately 150 microseconds. Again, those durations are non-limiting. Using such values, images produced corresponding to the different wavelength bands may be synchronized within approximately 100 microseconds, or less, of each other. Non-limiting examples of alternative ratios between the duration of integration on capacitor 504b compared to the duration of integration on capacitor 504a may be 1:1, 2:1, 3:1, and 4:1. However, alternative ratios are possible.

It should be appreciated that the above-described operation of a ROIC pixel may be utilized in snapshot mode of an imager, or in any other suitable mode. For instance, an imager may be operated in various modes. Snapshot mode is one mode of operation, in which the integration of pixels in all rows begins at approximately the same time. Another mode of operation is ripple mode, in which the integration of pixels in different rows begins at different times (e.g., the integration of each row is delayed by one row time from the integration of the previous row). Other modes are also possible. Thus, the various aspects described herein are not limited to any particular mode of operation of an imager.

According to an aspect of the present application, a power saving scheme is implemented in operating the CTIA amplifier of a ROIC pixel. The power saving scheme may comprise varying the bias on the CTIA amplifier such that a low bias is applied while the CTIA amplifier is integrating photocurrent and then a high bias is applied when the CTIA amplifier is driving its output to a load, such as storage and/or processing circuitry. In this manner, the time during which the CTIA amplifier is biased relatively high may be minimized, thus conserving power. In one embodiment, such a scheme may be implemented in ripple mode of an imager. A non-limiting example is now discussed.

As mentioned, in ripple mode the start of integration of the rows of the imager is staggered. For example, the integration of each row is delayed by one row time from the integration of the previous row. Thus, the readout of a row (i.e., the transferring of the output signals of the pixels of that row to the column circuitry) may begin when the integration period for that row ends, rather than waiting until the end of the integration of all rows. Accordingly, since the integrated photocurrent of an imaging pixel may be transferred to column circuitry as soon as integration ends, there may be no need to store the integrated photocurrent in the ROIC pixel. Referring to FIG. 5, in ripple mode of operation the illustrated pixel 500 may not include the processing channels 501a and 501b. Rather, the output 506 of the amplifier 502 may be coupled directly to column circuitry (e.g., a column line or bus) or may be coupled to the column circuitry via one or more source follower configurations (e.g., via the configurations of transistors 518a, 518b, 520a and 520b). Since, in such an embodiment, there may be no on-pixel storage (e.g., no sample and hold capacitors 514a and 514b), the amplifier 502 need not at all times be biased sufficiently to drive a load. Rather, the amplifier 502 may be biased with a relatively low value until the time at which the output of amplifier 502 is to be driven to the column line.

As mentioned, the amplifier 502 may be biased by a bias input 509. The bias input may assume a relatively low value while charge is being integrated on the capacitors 504a and 504b. When the output of the amplifier 502 is to be driven to column circuitry, the value of the bias input may be increased to a value sufficient to drive the output to column circuitry (e.g., to a column buffer, as a non-limiting example). As a non-limiting example, referring the timing diagram of FIG. 6, the bias input 509 may be lowered at about the time S₁ has a falling edge (e.g., the start of integration) and raised at about the time that S₄ has a rising edge. In this non-limiting example, then, the amplifier may be biased in a low state for approximately ⅘ of the illustrated integration period. It should be appreciated that other durations for biasing the amplifier in a low state may also be used (e.g., the amplifier may be biased in a low state for at least 50% of the pixel operation period, for at least 70%, for at least 75%, for at least 80%, for at least 90%, or for any other suitable duration), and the exact duration selected may depend on a desired integration period. Thus, it should be appreciated that significant power savings may be realized.

The values of the bias input 509 when in the lowered state and when raised to drive the output of the amplifier 502 may be any suitable values. As a non-limiting example, the ratio of the bias input when low to the bias input when high may be, for example, 1:4 (e.g., one microAmp as the low value and four microAmps as the high value), 1:3, 1:5, or any other suitable values. Taking into consideration the above-described non-limiting examples of the duration during which the amplifier may be biased by a relatively low value (e.g., at least 50% of the pixel operation, ⅘ of the pixel operation period, etc.), it should be appreciated that significant power savings may be realized compared to if the amplifier was biased in a high state throughout operation.

While the foregoing explanation of a power saving scheme according to an aspect of the present application has been described in the context of ripple mode, it should be appreciated that not all embodiments of power saving are limited to the ripple mode of operation.

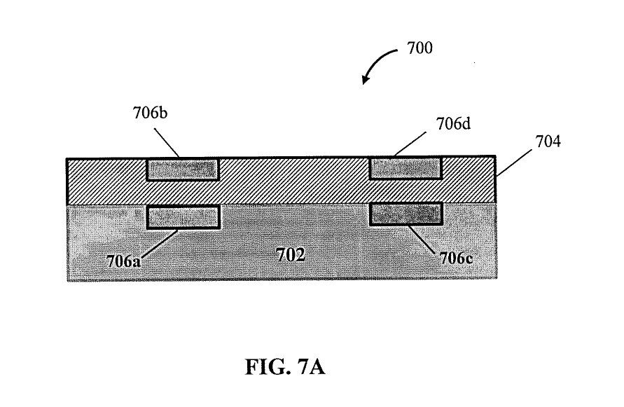

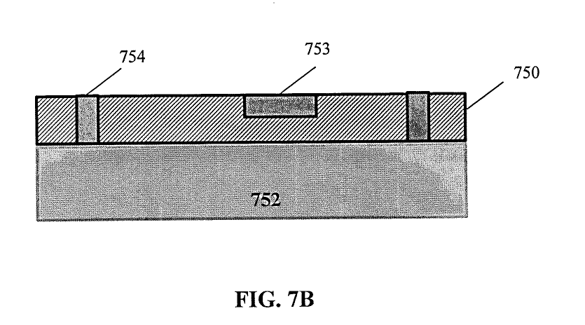

According to one aspect of the present application, a ROIC pixel configured to couple to a dual band or multi-band detector array includes two or more capacitors vertically stacked on a substrate. A non-limiting example is illustrated in FIG. 7A. However, referring first to FIG. 5, it should be appreciated that the illustrated pixel 500 includes multiple capacitors. Namely, two feedback capacitors and two sample and hold capacitors are illustrated. Forming such capacitors in an integrated circuit typically requires a substantial amount of space. Applicants have appreciated that vertically stacking two or more capacitors may result in space savings.

Accordingly, as shown in FIG. 7A, which is a non-limiting cross section of an exemplary physical configuration of some components of the ROIC pixel 500, two or more capacitors may be vertically stacked. The device 700 includes a substrate 702 (which, in some non-limiting examples, may be a semiconductor substrate such a silicon substrate) on which a first layer 704 is formed. The layer 704 may be an insulating layer or any other suitable layer. Capacitors 706a-706d are formed on the semiconductor substrate as two pairs of vertically stacked capacitors. As shown, capacitor 706b is vertically above capacitor 706a, while capacitor 706d is vertically above capacitor 706c. In those embodiments in which the device 700 corresponds to at least a part of a pixel of the type shown in FIG. 5, capacitors 706a-706d may represent any combination of the feedback and sample and hold capacitors shown in FIG. 5. As a non-limiting example, capacitors 706a and 706b may correspond to capacitors 514a and 504a of FIG. 5, respectively, or vice versa. Similarly, capacitors 706c and 706d may correspond to capacitors 514b and 504b, respectively, or vice versa. Alternatively, capacitors 706a and 706b may correspond to capacitors 514a and 514b of FIG. 5, as another non-limiting example. Other configurations are also possible.

The manner of stacking capacitors of a ROIC pixel shown in FIG. 7A may provide significant space savings in the physical implementation of the ROIC, in that all four of the capacitors need not be formed in the plane of the semiconductor substrate. Such vertical stacking may be accomplished in any suitable manner, and any suitable stacking configuration may be used. For example, the sample and hold capacitors may be stacked vertically above the feedback capacitors or vice versa. Alternatively, one feedback capacitor may be vertically stacked relative to the other feedback capacitor, and the two sample and hold capacitors may be vertically stacked with respect to each other.

According to another aspect, a ROIC pixel may be formed by dividing the circuitry of the pixel onto multiple substrates (e.g., silicon substrates). For example, referring to FIG. 7B, a first substrate 750 may be stacked relative to, and connected to, a second substrate 752. The first substrate may include, for example, the capacitors of pixel 500 (e.g., shown in simplified form as capacitor 753). The capacitors may be formed within a same plane, or two or more of the capacitors may be stacked as described in connection with FIG. 7A. The first substrate may be connected to the second substrate with one or more vias 754 (e.g., with through silicon vias (TSVs)). While one potential division of the circuitry of a ROIC pixel is to place the capacitors of the ROIC pixel on one substrate, not all embodiments in which the ROIC pixel is divided among multiple substrates are limited in this respect. Any suitable division of components between one or more substrates may be made.

According to one aspect of the present application, imagers having variable gain between rows (which may be referred to herein as “inter-row variable gain”) are described, i.e., pixels in different rows of the imager may have different gains. In one embodiment, a row of pixels is a set of pixels that are addressed by a common clock signal but which output signals to different output lines (or busses). For example, two or more pixels may be addressed by receiving a common clock signal (e.g., a common transfer signal), but may provide their respective output signals to respective column lines.

In one embodiment, a row includes a linear arrangement of three or more pixels, with each of the three of more pixels being connected to respective column circuitry (e.g., respective column buffers or respective column switches) such that the output signal(s) of each pixel in the row is provided to respective column circuitry. As an example, three pixels may be arranged linearly and connected to a respective column line having a column buffer. Each of the three pixels may output a respective output signal to its respective column line.

In one embodiment, rows of an imager represent a “slow readout axis” of the imager whereas columns of the imager represent a “fast readout axis”, meaning that alternating between processing signals of pixels (e.g., processing output signals of the pixels) from one row and processing signals of pixels from another row is performed less frequently during operation of the imager than is alternating between processing signals of pixels from one column and processing signals of pixels from another column. As a non-limiting example, first and second rows may each include 620 pixels. The first row of pixels may be selected and the output signals from those pixels may be read (or transferred) by sequentially selecting the 620 pixels of that row. Then, the second row of pixels may be selected and the output signals from those pixels may be read (or transferred) by sequentially selecting the 620 pixels of that row. In this manner, alternating between rows occurs more slowly than does alternating between columns (i.e., in this non-limiting example, 620 column transitions occur for each row transition).

Thus, it should be appreciated that, as used herein, the term “rows” is not limited to whether or not the pixels of the row are aligned horizontally or vertically or at any particular angle. Likewise, the language “inter-row variable gain” is not limited to any particular physical orientation, but again refers to differences in gain between pixels in different rows of an imager. The different gains may compensate for temperature induced differences in intensity of radiation impinging on the different rows of the imager or differences in target emissivity. However, the various aspects described herein are not limited to implementing or using variable gain between rows of an imager for any particular reason, as such aspects may be used for any reason.

According to one aspect, the variable gain functionality may be provided in the readout integrated circuit (ROIC) of an imager. The ROIC may be constructed and/or operated suitably to provide variable gain between the rows of the imager. For example, in a first non-limiting embodiment, the ROIC may implement (or cause to be implemented) different photocurrent integration period durations for at least two different rows. In another non-limiting embodiment, different integration capacitor sizes (i.e., different integration capacitances) may be implemented in pixels of different rows. In another non-limiting embodiment, the gain of a column buffer may be varied to have different values when receiving the output signals of pixels from different rows of the imager. Other techniques for providing variable gain between rows of an imager are also possible.

As mentioned, according to one aspect of the present application, inter-row variable gain may be provided by implementing different integration period durations between rows of an imager. Using different integration period durations for different rows of an imaging array may effectively create different gains for the different rows. In this manner, naturally occurring variations of intensity between radiation impacting different rows may be compensated. However, it should be appreciated that the aspects described herein relating to implementing different integration period durations for different rows of an imager are not limited to doing so for any particular purpose. Moreover, it should be appreciated that the different integration period durations for different rows may be implemented within the same integration frame in some non-limiting embodiments.

The number of different integration period durations implemented for rows of an imager is not limiting. According to one embodiment, different integration period durations may be implemented for each row of the imager. For example, if an imager includes 480 rows (e.g., a 640×480 imager), 480 different integration period durations may be used in operating the imager during a frame; one integration period duration for each row. Alternatively, rows may be grouped, and a different integration period duration may be used for each group of rows. Again considering the example of an imager with 480 rows, the rows may be grouped into groups of five, and 96 different integration period durations may be used in operating the imager during a frame. For instance, rows 0-4 may utilize a first integration period duration, rows 5-9 may implement a second integration period duration, and so on. In those embodiments in which rows are grouped, any number of row groups may be implemented (e.g., the rows of the imager may be grouped into two or more groups). In some embodiments, the number of groups selected may correspond to an expected number of wavelength bands to be projected on an imaging array. For example, if a dispersive element (e.g., a grating) is used to separate incident radiation into X different wavelength bands projected to different portions of an imaging array, then X groups of rows may be formed, wherein X may have any value of two or more. However, alternative manners for determining a number of row groupings to use are also possible. Also, it should be appreciated that the aspects described herein relating to providing inter-row variable gain are not limited to use with imagers having any particular number of rows, and therefore a 480 row imager is merely a non-limiting example.

It should also be appreciated that, as used herein, providing different gains to different rows of an imager may comprise providing different gains to at least one pixel in at least two different rows (e.g., providing a first gain to a first pixel in a first row and a second gain different than the first gain to a first pixel in a second row). In some non-limiting embodiments, providing different gains to different rows of an imager may comprise providing all pixels in one row of the imager with different gains than that provided to all pixels in another row (e.g., all pixels of row 1 may have gain 1 while all pixels in row 2 may have gain 2, as a non-limiting example). Similarly, then, it should be appreciated that providing different integration period durations to different rows of an imager may comprise providing different integration period durations to at least one pixel in at least two different rows, and in some non-limiting embodiments may comprise providing all pixels in one row with different integration period durations than all pixels in another row (e.g., all pixels or row 1 may use the same first integration period duration while all pixels in row 2 may use the same second integration period duration different than the first integration period duration, as a non-limiting example).

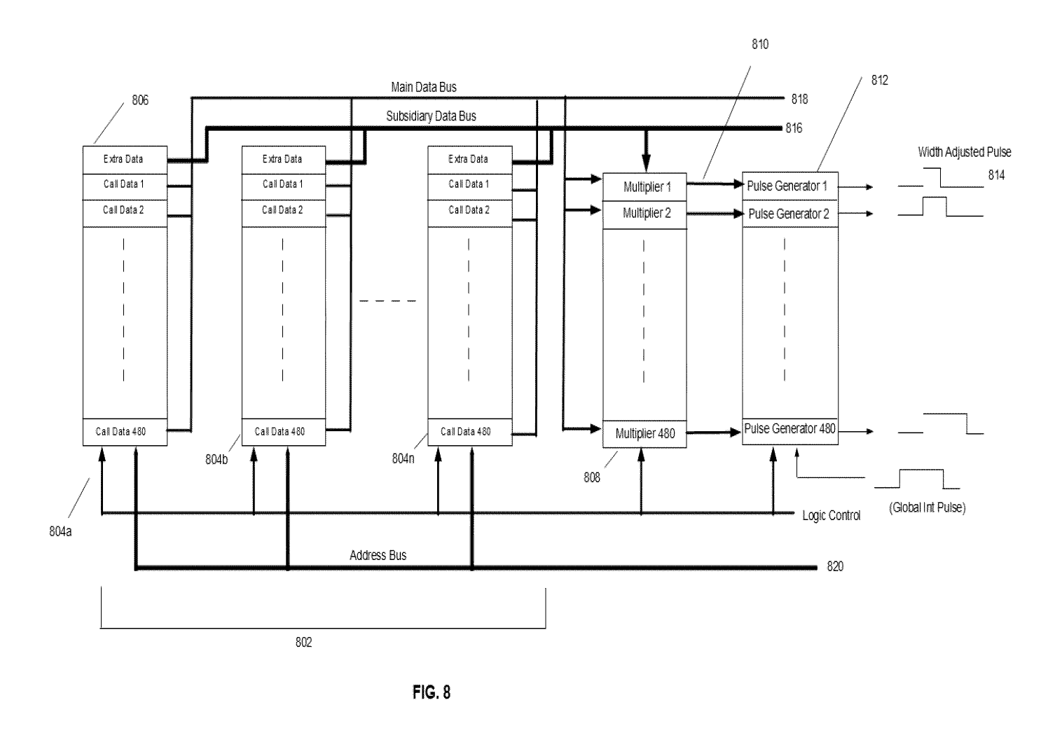

Implementation of different integration period durations for different rows of an imaging array may be accomplished in any suitable manner, and the various aspects described relating to providing different integration period durations for different rows are not limited in the manner of doing so. A non-limiting example is explained with respect to FIG. 8, though it should be appreciated that alternative implementations are possible.

FIG. 8 illustrates a portion of a ROIC according to an embodiment of the present application, including memory and timing circuitry. The timing circuitry may include pulse generators and multipliers, like the timing circuitry 306 shown in FIG. 3. However, the particular construction illustrated in FIG. 8 is non-limiting. The illustrated memory array 802 may be a portion of memory 304 of FIG. 3 or may be separate memory, as FIG. 8 is a non-limiting example. The multipliers may be part of the timing circuitry (e.g., as shown in FIG. 3), may be distinct from the timing circuitry in the ROIC, or may be related to the timing circuitry in any other suitable manner.

As shown, the memory may include a memory array 802 with multiple columns 804a-804n corresponding to different temperatures and multiple rows (or cells) 806. The rows 806 of the memory array 802 may store information which may be used to generate desired integration timing signals to control the integration period timing and duration of the rows (or groups of rows) of an imager.

In one embodiment, the memory array rows store calibration data (illustrated as “cal data”) or scaling factors for scaling the integration period duration of pixels of a corresponding row of an imaging array. The calibration data may be determined in any suitable manner. For example, in one non-limiting embodiment the calibration data may be determined by considering the blackbody radiation curve for a particular temperature. Based on the blackbody radiation curve, and an anticipated wavelength distribution across an imaging array (e.g., an anticipated assignment of certain wavelength bands to certain rows of an imager), the calibration data may be determined to provide a substantially uniform signal output level across the array despite differences in intensity due to blackbody principles. Alternatively, a gray body radiation curve may be used, rather than a blackbody radiation curve. As yet another alternative, some combination or weighting of a blackbody radiation curve and gray body radiation curve may be used. It should be appreciated, however, that the various aspects of the present application are not limited to determining the calibration data in any particular manner or to targeting any particular goal by using the calibration data (e.g., while uniform intensity across an imaging array may be targeted in some embodiments, not all embodiments are limited in this respect).

In a dual band (or multi-band) imager, it should be appreciated that a different calibration factor may be applied to each wavelength band detected by the pixels of a row. For example, in a dual band imager, two calibration factors per row may be used, with one corresponding to each wavelength band. However, the circuitry required to process two calibration factors per ROIC pixel to provide inter-row variable gain may be undesirably complicated in some scenarios. Thus, a relatively more simplistic implementation may utilize the construction of the memory array illustrated in FIG. 8 and provide a single calibration factor for each row, or group of rows, of the imager to be compensated. Selection of the calibration factor may be made in any suitable manner, and in some embodiments may be made to represent an average of a calibration factor that would be appropriate for the first wavelength band detected by the dual band imager and a calibration factor that would be appropriate for a second wavelength band detected by the dual band imager. As a non-limiting example, if a suitable calibration factor for a given row of an imager for a first wavelength band detected by pixels of that row is 0.4, and if a suitable calibration factor for a second wavelength band of that row is 0.5, in some non-limiting embodiments, the average (i.e., 0.45) may be utilized as the calibration factor for calibrating the integration period duration for an imaging pixel in that row.

Thus, it should be appreciated that the calibration data may take any suitable values. For example, the calibration data may range between 0 and 2, between 0 and 1, or have any other suitable values. Thus, the various aspects are not limited in this respect.

Furthermore, the calibration data may be determined at any suitable time. For example, the calibration data may be determined prior to operation of the ROIC and may be provided to the ROIC by a user via a computer user interface. Alternatively, the calibration data may be determined dynamically or updated periodically. Alternatives are also possible.

As mentioned, the columns of the memory array may correspond to different temperatures. For instance, the first column may correspond to a first temperature, the second column to a second temperature, and so forth. Thus, the rows of the memory array may store calibration data for a corresponding temperature. For a given temperature (e.g., a detected environmental temperature, a pre-programmed temperature, etc.), the calibration data may be read out from the rows of the column corresponding to that temperature and provided to corresponding multipliers 808.

There may be one multiplier 808 corresponding to each of the rows 806 of the memory array, though not all embodiments are limited in this respect. In such an embodiment, each multiplier may receive a corresponding scaling factor (or calibration data) from a corresponding row of the selected memory column. The multiplier may also receive a nominal integration period value (i.e., a value indicating a nominal integration period duration, which may also be referred to herein as a nominal integration time), which it may then multiply by the received scaling factor. The output of the multiplier 810 may then be provided to a pulse generator 812, which subsequently produces a corresponding width adjusted pulse 814. The width adjusted pulse may represent a timing signal supplied to a ROIC pixel, e.g., to pixel 500.

The nominal integration period value may be provided to the multipliers 608 in any suitable manner. According to one embodiment, each column 804a-804n of the memory array includes a row storing extra data. The extra data may represent the nominal integration period value. Also, as will be discussed further below, one of the rows, or one of the groups of rows, may have the longest integration period duration of any of the rows or groups for that given temperature. The extra data may include an indication of which row/group has the longest integration period duration and/or an indication of the value of the longest integration period duration. The extra data may be programmed prior to operation of the ROIC (e.g., by a user via a user interface) or may be received in any other suitable manner. Upon selection of the calibration data from a particular column of the memory array, the extra data (and therefore the nominal integration period value, in this non-limiting embodiment) may also be selected and provided to the multiplier 808. However, it should be appreciated that the nominal integration period may be provided to the multipliers in any suitable manner.

The number of pulse generators 812 provided may correspond to the number of rows of an imaging array. For example, if an imaging array includes 480 rows, 480 pulse generators 812 may be provided, with each of the pulse generators producing the timing signals corresponding to a respective one of the rows of the imaging array. The number of multipliers 808 is not limited in this respect. Rather, the number of multipliers 808 may correspond to the number of row groupings of the rows of the imaging array. For example, if each row of a 480 row imager is to receive its own unique integration period duration, then 480 multipliers 808 may be included. However, if the rows are grouped together in two or more groupings for purposes of providing different integration period durations, the number of multipliers 808 may correspond to the number of groupings of rows. The number of groupings of rows may be selected to provide any desired granularity in the selection of integration period durations across the imaging array.

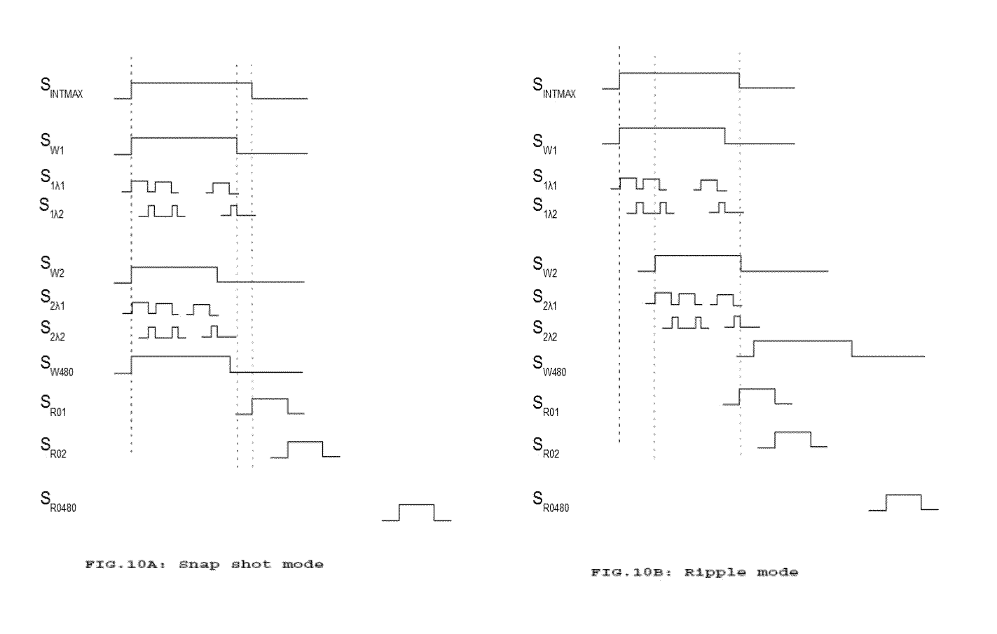

In addition to generating the integration signals, the pulse generators of FIG. 8 may generate transfer (or “readout”) signals for transferring the integrated charge from a pixel to column circuitry, such as a column buffer. Examples of such transfer or readout signals are shown and described in connection with FIGS. 10A and 10B. As explained in greater detail with respect to FIG. 10A, in some embodiments the transfer signals may not be started until the longest (or maximum) integration period for the imager has completed, such as when the imager is operated in snapshot mode. Thus, the maximum integration period may be provided to the pulse generators, as shown in FIG. 8 by the signal “Global Int Pulse”. The pulse generators may use the “Global Int Pulse” to properly time the transfer signals for reading integrated charge out of the pixels of the array.

Logic control, as illustrated, may be used to control, at least in part, which portions of the memory, multiplier circuit, and pulse generator column circuit are being used. The logic control may refer to clock signals used for such purposes, and the clock signals may take any suitable form.

Communication between the columns 804a-804n of the memory array 802 and the multipliers 808 may be accomplished in any suitable manner. According to one non-limiting embodiment, communication of the extra data, such as the nominal integration period value between the columns of the memory array and the multipliers may be performed via a subsidiary data bus 816. Communication between the columns of the memory array and the multipliers with respect to the scaling factors or calibration data for each row may be performed via a main data bus 818. However, it should be appreciated that alternatives are possible, and this is one non-limiting example. Data may be written to the memory array using the subsidiary data bus and the main data bus, or may be written and read in any other suitable manner.

A non-limiting example of calculation of integration period durations as may be performed using the circuitry of FIG. 8 is now provided for purposes of illustration. Assume that in the present example the relevant temperature is T and the relevant nominal integration period value is 100 mS. Knowing the temperature T, the circuit can locate the specific memory column which is associated with temperature T via the address bus 820. The calibration data in each row of the selected memory column is readout and is sent to the respective row of the multiplier column circuit. With the 100 mS nominal integration pulse and the calibration parameters, an integration pulse series which is row adjusted to compensate for the black body radiation variance across the different rows of the imaging array is generated for each row by the pulse generators and is sent to the pixel array to conduct the integration. The integration pulse series may be formed by, in some examples, multiplying the nominal integration pulse by the calibration parameters.

In addition, the last row of the selected memory column (the 481th row in this non-limiting example) is also read out to provide an indication of the row Rx which has the longest adjusted integration time. The pulse generators use such information about the longest adjusted integration time to generate the readout pulses (or transfer signals) after the longest integration time to assure that no conflict of integration and readout occurs.

It should be appreciated that in some embodiments the calibration data stored in the memory columns may represent values selected on the basis of an assumed nominal integration time which differs from an actual nominal integration time. As an example, the calibration data stored in the memory may be include values selected on the assumption that the nominal integration time is 1 second. If, in a particular application, the actual nominal integration time differs from the assumed nominal integration time (e.g., if the nominal integration time is 100 mS instead of 1 second), then it may be desirable in some scenarios to scale the calibration data itself. For example, if the calibration data is selected on the assumption that the nominal integration time will be 1 second but instead the nominal integration time is 100 mS, in some such embodiments the calibration data may itself be multiplied by a scaling factor k=0.1 to adjust the calibration data to account for the actual nominal integration time. However, such operation is a non-limiting example.

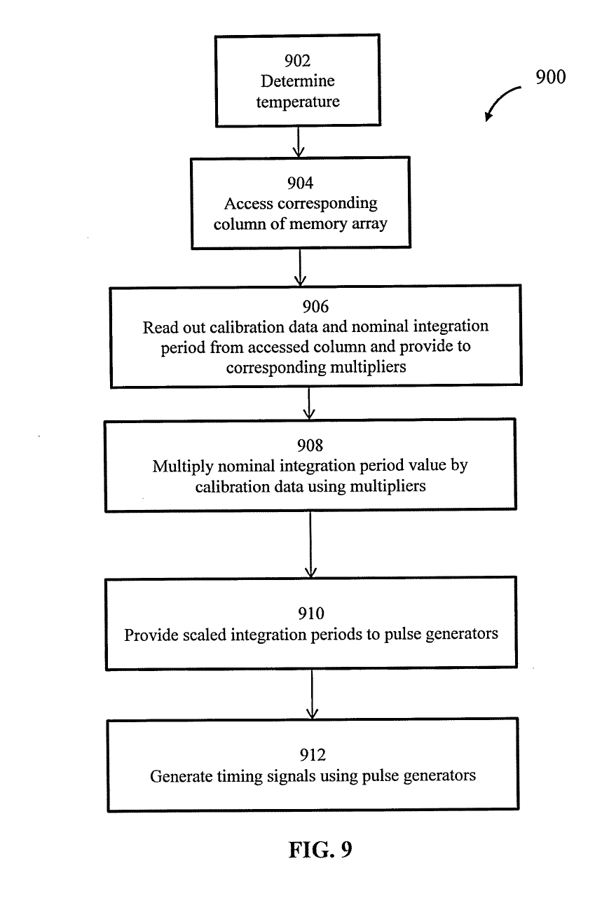

A non-limiting example of a manner of operation of the circuitry shown in FIG. 8 is now provided with respect to the flow chart of FIG. 9. As shown, the method 900 begins at 902 with determination of a temperature (in any suitable manner), such as the temperature of a scene to be imaged. Subsequently, using the determined temperature from step 902, the corresponding column 804a-804n of the memory array is addressed (or accessed) at 904 via an address bus 820. At 906, the extra data (e.g., the nominal integration period value) from the selected column as well as the calibration data of that column are provided to respective multipliers 808. At 908, the multipliers multiply the nominal integration period value by the received respective calibration data and provide the output 810 (e.g., a scaled integration period duration) to an appropriate pulse generator at 910. At 912, the pulse generators subsequently generate timing signals 814 which may be provided to ROIC pixels associated with a corresponding row of an imaging array. Thus, suitably scaled timing signals may be provided to rows or groups of rows of an imager to provide different integration period durations to the pixels of those rows. In this manner, inter-row variable gain may be realized.

FIGS. 10A and 10B illustrate non-limiting examples of timing diagrams corresponding to provision of inter-row variable gain between rows of a dual band imager in which a single calibration factor is used per row of the imaging array. FIG. 10A illustrates timing diagrams for operation of the dual band imager in snapshot mode, while FIG. 10B illustrates timing diagrams for operation in ripple mode.

With respect to FIG. 10A, timing diagrams for two rows (rows 1 and 2) of an imager are illustrated. The timing signal S_{W1} may represent the total integration period duration for a ROIC pixel associated with row 1 of the imager. Because FIG. 10A illustrates a dual band context utilizing a ROIC pixel of the type illustrated in FIG. 5, the integration period duration represented by signal S_{W1} may be divided between the two wavelength bands detected. The division may be represented by timing signals S_{1λ1} and S_{1λ2}, where S_{1λ1} represents the integration period for pixels in row 1 of the imager for wavelength band λ1 while S_{1λ2} represents the integration period for pixels in row 1 of the imager for wavelength band λ2. Signals S_{1λ1} and S_{1λ2} may be achieved by toggling in any suitable manner back and forth between the integration capacitors illustrated in FIG. 5 during the integration period S_{W1}, for example in the manner previously described in connection with FIG. 6. Similar operation with respect to pixels in row 2 of a dual band imager is illustrated by the signals S_{W2}, S_{2λ1}, and S_{2λ2}. The signal S_{W2} may represent the total integration period duration for a ROIC pixel associated with row 2 of the imager. S_{2λ1} represents the integration period for pixels in row 2 of the imager for wavelength band λ1. S_{2λ2} represents the integration period for pixels in row 2 of the imager for wavelength band λ2. The integration period duration for row 480 of the imager is also illustrated in FIG. 10A, though the individual integration periods for the two wavelength bands are not shown for that row, for simplicity. FIG. 10A also illustrates a timing signal corresponding to the maximum integration period duration (Sᵢₙₜₘₐₓ)

Read out of the pixels may be performed at the times illustrated by corresponding read out periods S_{R01}, S_{R02}, . . . S_{R0480}. In some embodiments, the read out periods may be broken into, or may comprise, two separate read out signals, with one corresponding to each of the wavelength bands detected for a given row of the imager. For example, S_{RO1} may be divided or otherwise used to generated signals S₆ and S₇ shows in FIGS. 5 and 6.

FIG. 10B illustrates a non-limiting example of the same signals as those from FIG. 10A only in ripple mode, rather than snapshot mode.

While various examples have been described with respect to provision of different integration period durations to different rows of an imaging array, it should be appreciated that alternatives are possible. For example, alternatives to both the circuitry and methodology described above for providing different integration period durations to different rows of an imaging array are possible. Thus, the foregoing examples are non-limiting and are provided for purposes of illustration.

According to another aspect of the present application, variable gain between rows of an imager may be achieved through use of different integration capacitances for ROIC pixels in different rows. As a non-limiting example, reference is again made to FIG. 5. Assuming that pixel 500 corresponds to a first row of an imager and that a similarly configured pixel corresponds to a second row of an imager, the values of the feedback capacitors for the two different pixels may differ. For example, the values of feedback capacitor 504a in pixel 500 may differ from the value of a corresponding feedback capacitor in a pixel corresponding to a second row of the imager. Similarly the value of feedback capacitor 504b may differ from the value of a corresponding feedback capacitor in a the pixel corresponding to the second row of the imager. In one embodiment, the value of feedback capacitor 504a may differ from the value of the corresponding feedback capacitor in a pixel corresponding to a second row of the imager and the value of feedback capacitor 504b may differ from the value of the corresponding feedback capacitor in the pixel corresponding to the second row of the imager. These, however, are non-limiting examples, and it should be appreciated that various configurations may be used to implement different integration capacitance values in ROIC pixels corresponding to different rows of an imager, thereby providing different gains to the different rows.

Thus, inter-row variable gain may be provided irrespective of whether the integration period durations differ between the pixels of the different rows. In other words, variable gain may be achieved using integration capacitors of different sizes in different rows, without the need to alter durations of the integration periods of the rows. In this manner, the timing circuitry may be simplified (e.g., the memory array and multipliers illustrated in FIG. 8 may be absent). However, variable integration period durations between rows of the imager may be combined with variable integration capacitances between the rows of the imager, in one non-limiting embodiment.

According to one embodiment, one or more integration capacitors of a ROIC pixel may be variable. For example, referring to FIG. 5, one or both of feedback capacitors 504a or 504b may be variable. The use of variable feedback capacitors may facilitate creating different integration capacitances in ROIC pixels of different rows to create gain differences between the rows, as described above.

According to another aspect of the present application, variable gain between rows of an imager may be provided via the column circuitry connecting or multiplexing pixels of different rows. As a non-limiting example, a column buffer interconnecting pixels from different rows of an imager may include an amplifier. The gain of the amplifier may be varied when receiving and processing signals from pixels of different rows, thus effectively creating a variable gain between pixels of different rows. In this manner, differences in intensity of radiation received by different rows of the imager may be compensated for, as previously explained herein.

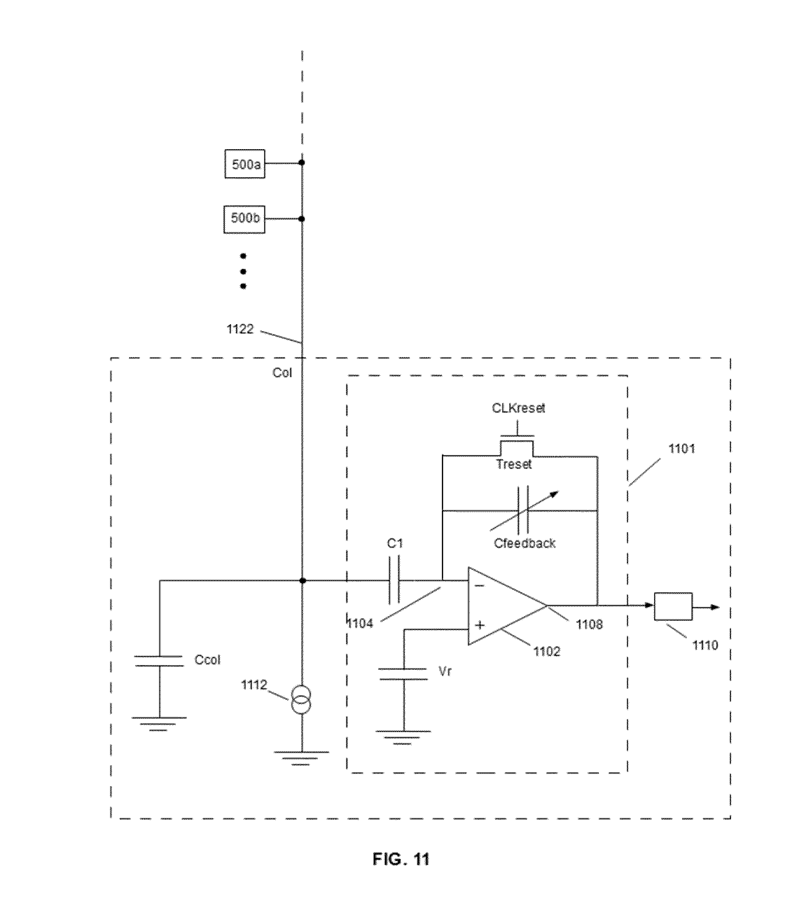

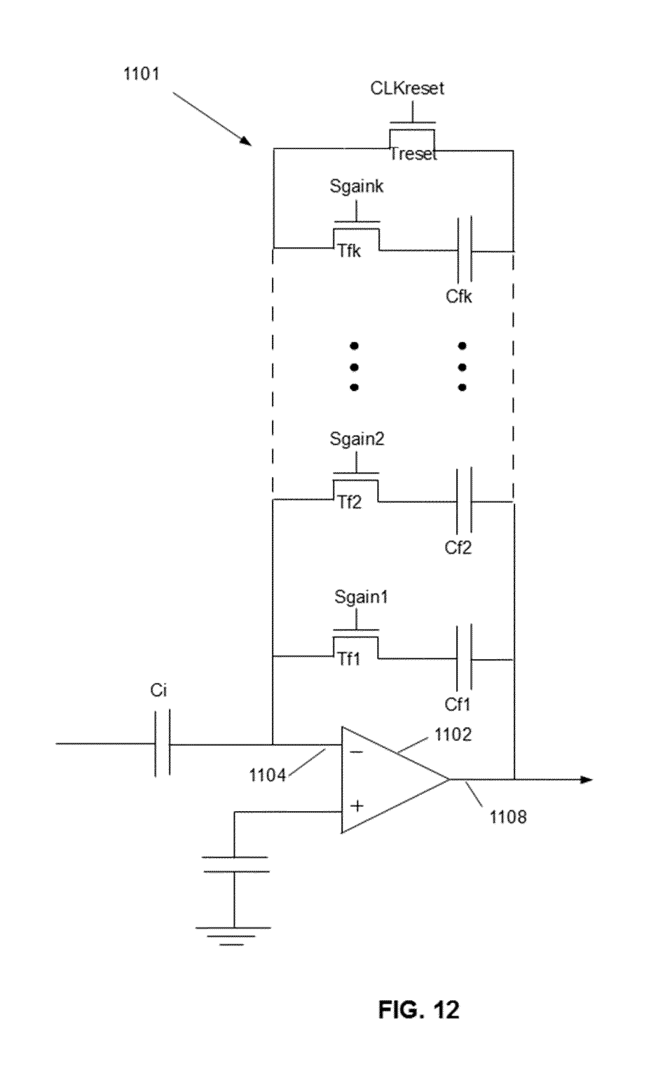

A non-limiting example is illustrated with respect to FIGS. 11 and 12. Referring first to FIG. 11, a non-limiting example of column buffer circuitry suitable for interconnecting rows of an imaging array and providing variable gain between the rows of the imaging array is illustrated. As shown, a column buffer 1100 is coupled to multiple ROIC pixels 500a and 500b, each of the type previously described in connection with FIG. 5, via a column bus 1122. While pixels 500a and 500b are illustrated, it should be appreciated that other types of pixels may be used. Moreover, the number of pixels coupled to the column buffer 1100 is not limiting.

In the non-limiting example shown, buffer 1100 comprises an amplifier block 1101, itself comprising an amplifier (or gain stage) 1102, an input capacitor Cᵢ, a feedback capacitor C_{feedback}, and a reset transistor Tᵣₑₛₑₜ. The amplifier 1102 has an inverting input terminal 1104, a non-inverting input terminal 1106 (which may be coupled to receive a reference voltage Vᵣ), and an output terminal 1108. The output of the amplifier block 1101 may optionally be coupled to circuitry 1110, which may be, for example, a sample and hold circuit or any other suitable type of circuitry. The reset clock CLKᵣₑₛₑₜ may control operation of the reset transistor Tᵣₑₛₑₜ, to selectively short circuit the output terminal 1108 of amplifier 1102 to the input terminal 1104 of amplifier 1102. The buffer 1100 may optionally include further circuitry such as a current source 1112. The column bus 1122 may have an associated capacitance C_{col}, as illustrated.

The gain of the buffer 1100 may be varied suitably to provide inter-row variable gain, i.e., differences in gain applied to pixels from different rows of an imaging array. For instance, the gain of the amplifier 1102 may assume a first value when the buffer 1100 receives and processes an output signal of pixel 500a and then may be varied to assume a second value when the buffer receives an output signal of pixel 500b. Assuming pixels 500a and 500b are associated with different rows of an imaging array, operating the buffer 1100 as just described results in application of different gains to pixels of different rows of the imaging array.

The gain of a column buffer may be varied in any suitable manner to realize inter-row variable gain, as the aspects described herein relating to varying the gain of a column buffer (or other column circuitry configured to receive and process signals from pixels of different rows of an imager) are not limited to the manner in which the gain is varied. However, a non-limiting example of a suitable manner for varying (or altering) the gain of a column buffer is now described with respect to FIG. 12.

The gain of the amplifier block 1101 may be given by −Cᵢ/C_{feedback}, such that the amplifier block 1101 may effectively operate as a charge amplifier. Thus, by varying the capacitance value of C_{feedback}, the gain of the buffer 1100 may be varied. Accordingly, C_{feedback} may be a variable capacitor according to a non-limiting embodiment. The capacitance value may be varied between when an output signal of a ROIC pixel associated with one row of an imager is received and when an output signal of a ROIC pixel associated with a different row of the imager is received. Also, the gain may be varied in response to environmental factors, such as lighting conditions (e.g., low light v. bright light scenarios, changes in temperature, differences in received light intensity owing to blackbody radiation effects for a single temperature, etc.), or for any other reason.

FIG. 12 illustrates one non-limiting example of a manner of implementing C_{feedback} as a variable capacitor. As shown, C_{feedback} may be implemented with k capacitors (C_{f1}, C_{f2}, . . . , C_{fk}) arranged in parallel between the input terminal 1104 and output terminal 1108 of amplifier 1102. Each of the feedback capacitors C_{f1}, C_{f2}, . . . , C_{fk} may be coupled to the input terminal 1104 of the amplifier 1102 by a respective switch, T_{f1}, T_{f2}, . . . , T_{fk}. Alternatively, the switches T_{f1}, T_{f2}, . . . , T_{fk} may be coupled between the respective feedback capacitor and the output terminal 1108 of amplifier 1102. The total feedback capacitance may thus be varied by turning on/off appropriate switches T_{f1}, T_{f2}, . . . , T_{fk} using their respective control signals S_{gain1}, S_{gain2}, . . . , S_{gaink}. In the non-limiting example of FIG. 16, k different values of capacitance can be switched into or out of the feedback path, providing up to 2k different values of gain for the column buffer.

As a non-limiting example of the operation of the circuitry in FIG. 12, the gain of the illustrated column buffer may be set to a first value by selection of a first combination of feedback capacitors C_{f1}, C_{f2}, . . . , C_{fk}. An output signal from pixel 500a may then be received and processed. The gain of the column buffer may then be adjusted to assume a second value different from the first value by selection of a different combination of the feedback capacitors C_{f1}, C_{f2}, . . . , C_{fk}. An output signal of pixel 500b may then be received and processed. Thus, a different gain may be applied to the output of pixel 500b than was applied to the output of pixel 500a. This manner of operation may continue for as many rows or groups of rows of the imaging array as is desirable. Thus, different gains may be applied to as many rows or groups of rows as is desirable.

According to one embodiment, a sufficient number of feedback capacitors may be provided to allow for as many different values of gain as there are rows of an imaging array with which the column buffer 1100 is to be implemented. For example, if a ROIC including the column buffer 1100 is to be implemented in a 480 row imager, then the number of feedback capacitors illustrated in FIG. 12 may take a value sufficient to allow for generation of up to 480 different gain values. In this manner, the buffer may potentially apply a different gain value to output signals received from pixels of each of the 480 rows of the imager. However, it should be appreciated that the aspects described herein relating to varying the gain of column circuitry (e.g., varying the gain of an amplifier of a column buffer) to provide inter-row variable gain are not limited to being able to provide any particular number of different gain values.

While FIGS. 11 and 12 illustrate examples of suitable column circuitry for providing inter-row variable gain, it should be appreciated that alternative circuitry and alternative methods of providing inter-row variable gain using column circuitry are possible. Thus, FIGS. 11 and 12 and the corresponding description are non-limiting examples.

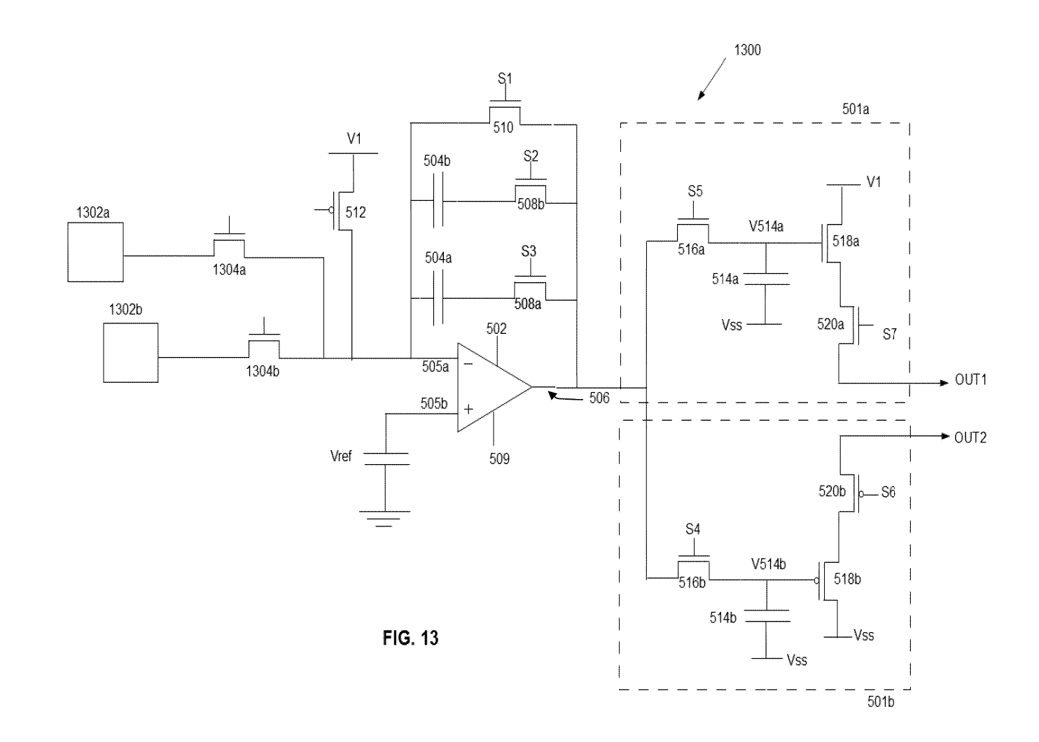

While some of the previously described embodiments have been explained in the context of a ROIC pixel of the type illustrated in FIG. 5 connecting to a single detector through a single connection, it should be appreciated that the various aspects of the present application are not limited to that context unless otherwise stated. For example, FIG. 13 shows a variation on the pixel 500 of FIG. 5 in which the ROIC pixel is connected to multiple detectors. As shown, the pixel 1300 is similar to the pixel 500 in many respects. However, the pixel 1300 is connected to two detectors 1302a and 1302b via respective switches 1304a and 1304b.

According to a non-limiting embodiment, the pixel 1300 may be suitable for operating with a dual band imager. The detector 1302a may detect a first wavelength band while the detector 1302b may detect a second wavelength band. The pixel 1300 may operate to integrate and process signals relating to both the first and second wavelength bands via suitable operation of the switches 1304a and 1304b. For example, the timing control of switch 1304a may be synchronized with the control of switch 508a, while the timing control of switch 1304b may be synchronized with control of switch 508b, as a non-limiting example.

Thus, rather than using a detector 202 configured to detect both wavelength bands, separate detectors 1302a and 1302b may be used. The ROIC may therefore connect to each detector of an imaging array via two bumps (i.e., a dual bump connection) rather than via a single bump connection. In other words, the aspects of the present application may apply to dual bump ROICs as well as to single bump ROICs, as non-limiting examples.

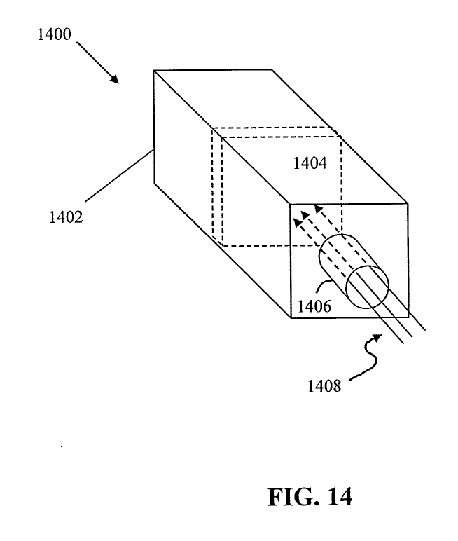

The various aspects of the invention described herein may be used in various devices, and are not limited to use in any particular types of devices. According to one embodiment, ROICs and methods according to any of the aspects described herein may be used to form at least part of an imaging device (e.g., a camera). For example, referring to FIG. 14, an imaging device 1400 (e.g., a camera) may include a housing 1402, an imaging array and ROIC 1404 disposed within the housing (for example, on two separate but coupled substrates, or on a single substrate), and optics 1406. The ROIC may be any of the types described herein. The optics may include any suitable optics (e.g., collimation optics, one or more lenses, one or more filters, etc.) for collecting and focusing incident radiation 1408 on the imaging array.

One or more of the various aspects described herein may apply to hyperspectral dual band imagers, multispectral imagers, active pixel CMOS imagers, or any other suitable imaging devices. The aspects described herein may also apply to detection of any desired wavelengths. For example, as mentioned, detection of MWIR and LWIR wavelengths may be performed using one or more aspects described herein. Non-limiting examples of other wavelengths of interest which may be detected according to aspects described herein include visible (VIS), near infrared (NIR), short wavelength infrared (SWIR), and very long wavelength infrared (VLWIR) radiation, among others. Dual band or multi-band imagers detecting any combinations of these wavelength bands, or portions of these wavelength bands, among others, may be implemented using one or more aspects described herein. Furthermore, in those aspects in which different wavelength bands are detected, the bands may be discontinuous (i.e., separated by some amount), continuous (e.g., visible and NIR bands), overlapping or non-overlapping, as the various aspects described herein are not limited in this respect.

Moreover, various benefits may be realized by application of one or more of the aspects described (though it should be appreciated that not all aspects necessarily provide each benefit). For example, compact dual band hyperspectral imagers may be realized, and may be suitable for operation at low flux levels. For example, dual band imagers according to one or more of the aspects described herein may provide satisfactory operation with flux densities as low as about 1 microWatt/cm², or even lower. ROICs suitable for use with dual band imagers may also exhibit significant space savings, for example due to the use of shared components (e.g., shared CTIA amplifiers among multiple processing channels per pixel) and vertical stacking of some components (e.g., vertical stacking of capacitors). Accordingly, compact dual band imagers may be realized. Other benefits may also be realized, as those listed are merely non-limiting examples.

One or more aspects and embodiments of the present application involving the performance of methods may utilize program instructions executable by a device (e.g., a computer, a processor, or other device) to perform, or control performance of, the methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments discussed above. The computer readable medium or media can be transportable, such that the program or programs stored thereon can be loaded onto one or more different computers or other processors to implement various ones of the aspects discussed above. In some embodiments, computer readable media may be non-transitory media.

Having thus described several aspects and embodiments of the technology, it is to be appreciated that various alterations, modifications, and improvements will readily occur to those skilled in the art. Such alterations, modifications, and improvements are intended to be within the spirit and scope of the technology. Accordingly, the foregoing description and drawings provide non-limiting examples only.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A readout integrated circuit (ROIC) comprising:
an operational amplifier having an inverting input configured to couple through a single connection to a first photodetector and a second photodetector of a photodetector array, a non-inverting input configured to receive a reference voltage, and an output configured to provide an output signal;
a first feedback capacitor coupled between the output of the operational amplifier and the inverting input of the operational amplifier;
a second feedback capacitor coupled between the output of the operational amplifier and the inverting input of the operational amplifier, the second feedback capacitor configured in parallel to the first feedback capacitor;
a first sample and hold channel comprising a first sample and hold capacitor switchably coupled to the output of the operational amplifier by a first switch; and
a second sample and hold channel comprising a second sample and hold capacitor switchably coupled to the output of the operational amplifier by a second switch, wherein the second sample and hold channel is configured in parallel to the first sample and hold channel,
wherein the first sample and hold channel is configured to provide a first output signal indicative of detected radiation in a first wavelength band as detected by the first photodetector, and
wherein the second sample and hold channel is configured to provide a second output signal indicative of detected radiation in a second wavelength band as detected by the second photodetector.

2. The ROIC of claim 1, wherein the first feedback capacitor forms at least part of a first feedback loop between the output of the operational amplifier and the inverting input of the operational amplifier, and wherein the first feedback loop further comprises a third switch configured to switchably open circuit the first feedback loop.

3. The ROIC of claim 2, further comprising a reset switch coupled in parallel with the first feedback loop and configured to short circuit the output of the operational amplifier to the inverting input of the operational amplifier.

4. The ROIC of claim 1, wherein the first sample and hold channel is configured to conduct current in a first direction, the first direction being either toward or away from the first photodetector and second photodetector, and wherein the second sample and hold channel is configured to conduct current in a second direction opposite the first direction.

5. The ROIC of claim 1, wherein the first sample and hold channel is configured to be in a conductive state while the second sample and hold channel is in a non-conductive state.

6. The ROIC of claim 1, further comprising timing circuitry configured to supply timing signals to the first and second switches.

7. A readout integrated circuit (ROIC), comprising:
a capacitive transimpedance (CTIA) amplifier having an input, an output, a first feedback capacitor, a second feedback capacitor, a first switch, and a second switch,
wherein the input is configured to be coupled to a detector,
wherein the first feedback capacitor and first switch are coupled between the output and the input to form a first feedback loop, and
wherein the second feedback capacitor and the second switch are coupled between the output and the input to form a second feedback loop in parallel with the first feedback loop.

8. The ROIC of claim 7, wherein the detector is a first detector of a photodetector array, and wherein the input is configured to be coupled to the first detector through only a single connection.

9. The ROIC of claim 8, wherein the first detector comprises a first photodetector configured to detect radiation in a first wavelength band and a second photodetector configured to detect radiation in a second wavelength band.

10. The ROIC of claim 7, further comprising:
a first storage path coupled to the output of the CTIA amplifier; and
a second storage path coupled to the output of the CTIA amplifier,
wherein the first and second storage paths are configured in parallel to each other.

11. The ROIC of claim 10, wherein the detector is a first detector of a photodetector array,
wherein the first storage path is configured to store a first signal indicative of an amount of detected radiation in a first wavelength band as detected by the first detector, and
wherein the second storage path is configured to store a second signal indicative of an amount of detected radiation in a second wavelength band as detected by the first detector.

12. The ROIC of claim 11, wherein the first storage path comprises a first storage capacitor.

13. The ROIC of claim 12, wherein the first storage path comprises a first sample and hold circuit comprising the first storage capacitor and wherein the second storage path comprises a second sample and hold circuit.

14. The ROIC of claim 12, wherein the first storage capacitor and the first feedback capacitor are formed in a semiconductor substrate with one vertically above the other.

15. The ROIC of claim 11, wherein the first wavelength band corresponds to at least a portion of a medium wavelength infrared (MWIR) band, and wherein the second wavelength band corresponds to at least a portion of a long wavelength infrared (LWIR) band.

16. A system comprising the ROIC of claim 7 coupled to a photodetector array comprising the detector.

17. The ROIC of claim 7, further comprising timing circuitry configured to supply control signals to the first and second switches.

18. A method of operating a readout integrated circuit (ROIC) configured to couple to a photodetector array, the method comprising:
integrating a photocurrent from a detector of the photodetector array on a first feedback capacitor of a capacitive transimpedance (CTIA) amplifier during a first time period;
integrating the photocurrent from the detector of the photodetector array on a second feedback capacitor of the capacitive transimpedance amplifier during a second time period; and
sampling an output voltage of the capacitive transimpedance amplifier.

19. The method of claim 18, wherein the photocurrent from the detector during the first time period is indicative of radiation in a first wavelength band detected by the detector and wherein the photocurrent from the detector during the second time period is indicative of radiation in a second wavelength band detected by the detector.

20. The method of claim 18, wherein photocurrent is not integrated on the second feedback capacitor during the first time period and wherein photocurrent is not integrated on the first feedback capacitor during the second time period.

21. The method of claim 20, wherein sampling the output voltage of the capacitive transimpedance amplifier comprises sampling the output voltage of the capacitive transimpedance amplifier during a third time period using a first sample and hold circuit and sampling the output voltage of the capacitive transimpedance amplifier during a fourth time period using a second sample and hold circuit.

22. The method of claim 21, wherein the first, second, third, and fourth time periods collectively form at least part of a same integration period.

23. The method of claim 21, wherein the output voltage of the capacitive transimpedance amplifier during the third time period is indicative of radiation in a first wavelength band detected by the detector, and wherein the output voltage of the capacitive transimpedance amplifier during the fourth time period is indicative of radiation in a second wavelength band detected by the detector.

24. The method of claim 23, wherein the photocurrent from the detector during the first time period is indicative of radiation in the first wavelength band detected by the detector and wherein the photocurrent from the detector during the second time period is indicative of radiation in the second wavelength band detected by the detector.

25. The method of claim 18, further comprising integrating the photocurrent from the detector of the photodetector array on the first feedback capacitor during a first plurality of time periods including the first time period and integrating the photocurrent from the detector of the photodetector array on the second feedback capacitor during a second plurality of time periods including the second time period,
wherein time periods of the first plurality of time periods alternate with time periods of the second plurality of time periods, and
wherein the first plurality of time periods and the second plurality of time periods collectively form at least part of a same integration period.

26. The method of claim 25, wherein at least some time periods of the first plurality of time periods differ in duration from at least some time periods of the second plurality of time periods.

27. The method of claim 26, wherein all time periods of the first plurality of time periods differ in duration from time periods of the second plurality of time periods.

28. The method of claim 25, wherein the first plurality of time periods, the second plurality of time periods, the third time period, and the fourth time period collectively form at least part of the same integration period.

29. The method of claim 18, further comprising applying a first bias signal to the CTIA amplifier during the first and second time periods and applying a second bias signal to the CTIA amplifier while sampling the output voltage of the CTIA amplifier, the second bias signal having a greater value than the first bias signal.

30. A method of operating a readout integrated circuit (ROIC), comprising:
alternately integrating photocurrent on first and second feedback capacitors of a same capacitive transimpedance amplifier to selectively integrate photocurrent corresponding to a first wavelength band of radiation on the first feedback capacitor and photocurrent corresponding to a second wavelength band of radiation on the second feedback capacitor.
